(19) United States
(12) Patent Application Publication
(10) Pub. No.: US 2018/0060981 A1
(43) Pub. Date: Mar. 1, 2018

(54) NETWORK-LEVERAGED REAL ESTATE TRANSACTION ASSISTANCE SYSTEM AND METHOD

(71) Applicant: Robert Sher, Chicago, IL (US)

(72) Inventor: Robert Sher, Chicago, IL (US)

(21) Appl. No.: 15/692,645

(22) Filed: Aug. 31, 2017

Related U.S. Application Data
(60) Provisional application No. 62/381,670, filed on Aug. 31, 2016.

(51) Int. Cl. G06Q 50/16; G06F 17/30; G06Q 30/02

(52) U.S. Cl. CPC G06Q 50/163; G06Q 50/167; G06Q 30/0201; G06F 17/30241; G06F 17/30867

(57) ABSTRACT

A network-leveraged real estate transaction assistance system is provided to facilitate matching, engaging, contracting, and communicating between parties to a real estate and/or property rental transaction by a network-leveraged system. The network-leveraged real estate transaction assistance system may include a property rental and real estate transaction assistance platform, database, platform components, renter component, matching component, communication component, broker-assisted component, landlord direct component, landlord management component, lead marketplace component, guaranteed rental income protection, renter profile validation aspect, and tenant exchange. A method for facilitating matching, engaging, contracting, and communicating between parties to a real estate and/or property rental transaction by a network-leveraged system using the network-leveraged real estate transaction assistance system is also provided.

### CROSS-REFERENCE TO RELATED APPLICATION

This application claims the priority from U.S. provisional patent application Ser. No. 62/381,670 filed Aug. 31, 2016. The foregoing application is incorporated in its entirety herein by reference.

### FIELD OF THE INVENTION

The present disclosure relates to a network-leveraged real estate transaction assistance system. More particularly, the disclosure relates to facilitating matching, engaging, contracting, and communicating between parties to a real estate and/or property rental transaction by a network-leveraged system. The present disclosure additionally relates to income protection, payment platforms, securitized rental transactions, and non-rental transactions.

### BACKGROUND AND TECHNICAL PROBLEMS

The traditional residential rental process is slow, inefficient, and lacks transparency, which can create a large time and cost burden on renters, landlords, and agents. No known reference provides a much-needed paradigm shift to upgrade virtually all things real estate by simplifying the rental process for renters, landlords, and agents.

The current industry experiences renter-side problems. Renters often incur losses due to a flawed rental process calculated by the loss of time and money. Application fees cause the current rental searching process to be cumbersome, sometimes requiring renters to spend significant money on application fees while applying for units with multiple landlords.

Additionally, during the application process, renters are subjected to a FICO credit review. Often, this review occurs multiple times with multiple credit retrievals that damage the renter's FICO Score. Moreover, renters are judged by the same credit standard mortgage banks use to underwrite mortgage loans. The car industry uses a “FICO Auto Score”. The mortgage lending industry uses the standard FICO score. Furthermore, rent payment performance is not reported to the credit bureaus. Many qualified renters with low FICO or other difficult past are often considered too high a risk to be qualified to rent, and many renters face a real threat of homelessness. No known practice can consider actual renter risk to prevent good renters, regardless of their FICO, to being grouped with bad renters and left with few to no housing options.

Furthermore, renters are generally forced to compete for apartments whenever those apartments become available and marketed on various websites. Competition is a major hurdle for renters. Even if there are three great candidates applying for the same apartment, there can only be one lease. This is highly inefficient, and renters have no organized data resource which would allow renters to apply for apartments in anticipation of an upcoming vacancy. There is no currently known way for renters who were not selected for a rental to reuse their application with a different landlord and avoid another application fee and another credit check.

Renters generally must either use agents or online listing platforms. However, data is not shared across the platforms. If the renter uses an agent and then finds an apartment through a listing service or on their own, their information is stuck with the agent. Alternatively, if a renter applied with a landlord and the application did not result in a lease, the renter must start all over with another landlord or broker—often being forced to complete new paperwork, pay more application fees, have their credit score run again, and spend additional time, money, and/or energy restarting the same process somewhere else.

Sometimes, listing data is inaccurate compared to what a landlord says over the phone. Landlords can give one renter one price, another renter a different price, and lease terms and cost to sign can vary greatly. If listing data is different from the info the landlord gives, this creates confusion which isn't easily rectified. Other than flagging an advertisement, there is no way for the renter community to update “true-up” listing info.

When a renter finally rents an apartment, unknown bad conditions may become known, including bad neighbors; hidden issues in the building like mold, radon, bugs, rodents, or gang and drug activity. Mainstream online review outlets can't be trusted to uncover these issues. Many renter lease defaults are a result of these hidden truths.

Furthermore, renters currently don't have an option to join an online “renter only” community where they can engage other renters and tenants in a social media setting. Additionally, there are no known renter-member platforms where renters can engage in commerce with other renter members and/or third parties to buy, sell, and trade goods and/or services. Furthermore, renters currently do not have an option to join an online “renter only” community where they can engage other renters and tenants in a social media setting. Additionally, there are no known renter-member platforms where renters can engage in commerce with other renter members and/or third parties to buy, sell, and trade goods and/or services.

The current industry experiences broker-side problems. Agents are busy people who spend a lot of time trying to market and sell to successfully earn money. Comparing rental and sales commissions, sales commission can be from $2,000 to $18,000 per closing and is many times higher than a rental commission which can be from $250 to $1,500 per closing. As result, most busy agents would rather pass-up a rental lead and focus on sales leads. Rental Agents who focus on residential leasing would often rather network and invest in marketing rather than do all the repetitive tasks of qualifying, matching to property, and showing apartments, as supportive work is a huge investment of time and money with very little return. For example, agents routinely lose time on application screening; gathering renter paperwork, forms, and verifications; organizing communication between calls, texts, and emails; matching renters to apartments; showing apartments; and/or completing and delivering a lease.

Agents also incur tremendous expenses during their regular course of business. Many rental agents waste money on MLS fees or a commission split with a cooperating agent. For example, a $1000 rental can easily turn into a $150 commission after the agent splits their commission with the cooperating agent; pays his/her broker split; and pays a myriad of other mandatory office, license, MLS, D&O insurance, association fees, closing and/or office fees. For most agents, the cost of working at a brokerage is hidden or unknown until closing their first deal. There is no known clear way of learning in advance what sort of compensation an agent will earn working for a brokerage. Moreover, some brokerages have a culture of poaching leads from agents, not paying commissions, reducing commission without warning, and not disclosing all costs payable to the brokerage when a deal closes. There are no known trustworthy reviews about brokerages.

Real property viewing expense can be an issue. To make money, an agent generally must perform leasing activities with their own related costs, including fuel spent on showings, car insurance, car maintenance, and car payments. While under pressure to meet financial obligations, some agents may give a landlord an application lacking adequate renter data to determine a renter's qualifications. Some agents will even withhold critical renter data and send an application to a landlord knowing the renter is not qualified to rent and/or has a high probability of default. Currently there is no known, simple, and affordable management tool available to an agent or brokerage to track worker accountability and generate reports for advertisers, landlord data procurement personnel, agent team members, and office staff.

Some brokerages will give leads to agents. Some third-party companies offer to sell leads to agents. There is no known simple way for agents to sell, transfer, and/or track leads serviced by other agents. Additionally, if a lead is transferred within an agent's team or sold to other agents, the lack of lead process transparency can be a major hurdle which prevents the buy/sell/transfer of leads and inhibits the growth of team structures. Lead tracking within a brokerage is possible with a strong process and lots of paperwork, messaging, and updates. However, once a lead is referred to agents outside of the brokerage, tracking is nearly impossible and business is then transacted on an honor system. The lack of trusted leads tracking for referral compensation can lead to a “lone wolf syndrome”, which can cause most agents to work on their own, not share leads, not share information, and not work in teams. Agents simply lack a transparent process that will give agents assurance that their referred lead will get serviced, and that the referring/originating agent will get paid when the referred lead closes.

High producing teams, once built, are not currently monetizable. Real Estate companies can be bought and sold, but not agent teams created by agents, not by brokerages. Agent created teams, is an investment not easily monetizable and it is currently not easily transacted by an agent that may want buy, sell or transfer a team that produces income or controls assets.

An agent invests a lot of time and energy to consistently procure rental listings. Setting a listing appointment, driving to the listing appointment, spending two to three hours filling out the myriad of listing forms on paper, inputting the same information into the MLS, then the agent's CRM, sending a copy of the listing to the broker, getting signature from the broker to then send signed copies to the landlord, then again more typing of the same information into online listings such as Craigslist, Zillow and other advertising websites. One new listing process that does not exist in the MLS can easily take half a day, even with the help of electronic document signing services because of the many forms and lengthy input procedure.

Once a unit is filled, there may be leftover applicants. For agents and landlords, organizing rental leads is also very complicated. Phone intake, emails, documents, forms, text messages, application and verification forms, questionnaires, and scheduling all takes a tremendous amount of time. Agents and landlords collect dozens of renter applications for each rental listing while a unit is on the market. After a landlord or agent fills the rental property, leftover renter applications are often discarded. No known platform exists to easily convert these leads, into money, which an agent or landlord worked so hard to accumulate.

The industry currently lacks solutions for landlord-side problems. Even with tools such as FICO Scores, criminal and eviction reports, income verifications, rental verifications, and personal references, landlords can still get surprised with having to evict their tenant. This can in part be due to lack of data transparency. Despite the positive references, landlords may have an incomplete picture as to whether a renter will really pay rent. There is no known rental payment reporting with the credit bureaus (Experian, Transunion, Equifax). Also, if a landlord wants to get rid of a tenant, a landlord can lie to a prospective future landlord of the tenant and claim rent payments were on-time. Other issues that lack transparency can include how the renter behaved around his previous neighbors or whether the renter was polite to the maintenance people and landlord.

For a landlord, trying to find the right tenant consumes tremendous energy, involving numerous emails and phone calls, screening applications, verifying all the info received, and conducting real property showings and interviews. No known website or technology exists that gives landlords the option to hand-pick renters from a renter candidate list which compares and matches the landlord's criteria and/or requirements against the profiles of renter candidates. Renters have long been able to search through a listing website for apartments, however landlords have no such feature to find tenants, where a renter's or tenant's profile can be searched and reviewed before contacting that renter or tenant.

Presently, landlords find renters by publishing their apartment for rent. This publication usually happens once the landlord learns a current tenant is moving out. Currently, there is no option for renters to contact landlords with an offer to lease in advance of a scheduled lease expiration. Landlords cannot passively receive rental applications unless landlords advertise their apartments for rent. Landlords who've dealt with the cost of eviction understand the value of income protection. While some products may attempt to offset eviction costs, no known product exists that will protect the landlord's rental income.

If a tenant requests a service, the investigation and resolution process is complicated and time consuming. Landlords must investigate the maintenance issue, call their maintenance person, and confirm that maintenance was performed to the landlord's standards. This is time-consuming. Many landlords do not have established relationships with maintenance crew, vendors, and various supportive services. Finding qualified people to answer landlord's specific service needs, including but not limited to tenant service requests, is difficult. More importantly, there is no known system that integrates all these services with a landlord's property management and bookkeeping system.

Landlords have long kept track of revenue and expense by building. There is no known system that allow landlords to easily analyze and view revenue and expense reports by unit. Furthermore, landlords have no known simple and affordable system or method to substantially automatically track and report timeliness of renter payment, frequency and severity of maintenance issues, and other issues as components of a weighted renter/tenant score. Furthermore, renter-to-landlord, renter-to-renter, and renter-to-vendors interaction is not accounted for nor quantified and factored into a score. A process is needed to further define the quality of the renter and create transparency, efficiency, and fairness.

Therefore, a need exists to solve the deficiencies present in the prior art. What is needed is a system to modernize the traditionally slow and laborious process involved in a property rental transaction. What is needed is a system to analyze potential tenants using criteria of rules and match potential tenants with compatible landlords. What is needed is a system to determine a financial profile of a user using novel and effective criteria indicative of a likelihood of compliance with obligations of a transactional relationship. What is needed is a system and method to facilitate management of a property rental and/or real estate transaction for landlords, brokers, and other parties. What is needed is a system and method to manage substantially real-time landlord and real property listings and permitting continuing updates to same. What is needed is a network-leveraged system to perform a preliminary analysis of prospective parties to a property rental and/or real estate transaction to quantify and measure continued interaction, such as viewing of a proposed unit subject to the lease or sale transaction and beyond. What is needed is a method for operating a network-leveraged system to facilitate a property rental and/or real estate transaction, to maintain continuing relationship between parties.

### SUMMARY

An aspect of the disclosure advantageously provides a system to modernize the traditionally slow and laborious process involved in a property rental transaction. An aspect of the disclosure advantageously provides a system to analyze potential tenants using criteria of rules and match potential tenants with compatible landlords. An aspect of the disclosure advantageously provides a system to determine a financial profile of a user using novel and effective criteria indicative of a likelihood of compliance with obligations of a transactional relationship. An aspect of the disclosure advantageously provides a system and method to facilitate management of a property rental and/or real estate transaction for landlords, brokers, and other parties. An aspect of the disclosure advantageously provides a system and method to manage substantially real-time landlord and real property listings and permitting continuing updates to same. An aspect of the disclosure advantageously provides a network-leveraged system to perform a preliminary analysis of prospective parties to a property rental and/or real estate transaction to qualify and measure continued interaction, such as viewing of a proposed unit subject to the lease or sale transaction and beyond. An aspect of the disclosure advantageously provides a method for operating a network-leveraged system to facilitate a property rental and/or real estate transaction, to maintain a continuing relationship between parties. An aspect of this disclosure advantageously provides a method for a renter community to engage in an exchange or commerce of goods and/or services. An aspect of the disclosure advantageously provides a method and option for renters, landlords, agents, and third parties to create separate and/or sub-communicates to engage as a renter/tenant only social media, peer-to-peer communication.

Aspects of this disclosure may provide a new set of rules for the real estate rental market upon which it will create a first ever renter score, a financial model to issue credit instruments, advertising, leads, and teams commerce platforms, renter multiple listing service (RMLS), bundle lease securities, guaranteed rental income protection (GRIP), dynamic virtual teams, management tools for landlords and brokers, rental process which is not focused on the FICO, renter managed real-time landlord listing updates, automated listing services for agents and landlords, renter community where renters can pay rent and request maintenance in person or online, and renter/landlord/agent/vendor reviews and ratings. A renter process may be provided that allows renters to navigate through a broker process and landlord process substantially faster, simpler, and simultaneously, without needing multiple application fees, to sign a lease in person or online, quickly and easily. A renter and landlord process where renters and landlords can upload proof of renter payment to build credibility and supportive documentation for renter and landlord, and for which a verification feature will create additional measures of confidence that the information provided by either or both the parties is true.

Aspects of this disclosure may allow renters to use a broker or not, for example, a direct-to-landlord process. With landlord direct, a renter may use an automated web-based system to complete the entire rental process. If the renter prefers the guidance of a real estate agent, a broker-assisted process may provide the renter a mostly-automated web-based system to complete the entire rental process, and still enjoy the benefits of having an interaction with a real estate professional. These options may employ the latest software technology to provide automated on-boarding process options to quickly process and assist renter applicants through the entire rental experience including searching, applying, scheduling, viewing, reviewing, negotiating, lease signing, continuing the use of the system throughout the duration of their tenancy, and exiting the lease. Aspects of this disclosure may allow renters to pay rent online, join an online renter community, make maintenance requests, rate landlords, neighbors, vendors, products, and services.

Accordingly, the disclosure may feature a network-leveraged system for facilitating a real property transaction including a database, platform components, and an interface. The database may be accessible via a network to store and communicate data relating to a transactional relationship and rules for determining a likelihood of compatibility between parties including a renter and a landlord. The platform components may be communicably connected to the database to analyze and manipulate the data. The platform components may include a renter component, a matching component, a broker-assisted component, and a lead marketplace component. The renter component may manage a renter profile including renter information and analyze at least part of the renter profile to derive a renter score for association with the renter. The renter score may be includable by the renter profile. The matching component may compare at least part of the renter profile to the rules to determine whether the likelihood of compatibility with a landlord requirement relative to a real property unit meets a matching threshold, and matching the renter and the landlord for which the matching threshold is met. The broker-assisted component may assist an agent with the transactional relationship. The broker-assisted component may include an agent renter CRM aspect and a renter qualification aspect. The agent renter CRM aspect may at least partially automate tasks related to the transactional relationship. The renter qualification aspect may work with the matching component to substantially identify the renter with the likelihood of compatibility with the landlord for the real property unit in consideration for the transactional relationship. A token exchange aspect may coordinate sharing of at least part of the renter profile from the renter to the landlord, the renter granting access to an authorization token for the landlord of the real property unit for consideration for the transactional relationship, and wherein the authorization token is revocable. The lead marketplace component may selectively transact the renter profile. The interface may be accessible to interact with the data and at least one of the platform components.

In another aspect, the system may include a guaranteed rental income protection to assure financial stability in the transactional relationship. The rules may include a threshold of eligibility for the guaranteed rental income protection. The guaranteed rental income protection may be selectively offered for the transactional relationship that meets a threshold of eligibility. The guaranteed rental income protection may be marketable as a financial instrument.

In another aspect, the renter component may further include a renter profile validation aspect to receive documentation that is intended to validate at least part of the renter information included by the renter profile. The renter information determined not to be valid may be selectively purged from the renter profile.

In another aspect, the rules may include the matching threshold for the likelihood of compatibility, an assessment of renter qualification factors, and an ability to afford rent for the real property unit.

In another aspect, the renter score may be determined from analyzing renter qualification factors including an income status, a family size status, a creditworthiness status, and a regulatory restriction status.

In another aspect, the broker-assisted component may further include a commission protection aspect including an escrow to mitigate an attempt by the parties to bypass the agent.

In another aspect, the broker-assisted component may further include a team module including a virtual team aspect to facilitate sharing leads with the agent, an agent management aspect for assigning the agent to a managing broker, and a team monitoring aspect to analyze statistics relative to the agent and determine the data relative to performance of the agent. At least part of the data may be associable with the agent.

In another aspect, the platform components may further include a landlord direct component including a renter search aspect to locate the renter prospective to engage in the transactional relationship relative to the real property unit, the renter being filterable by the renter score. The landlord direct component may communicate with the matching component to connect the renter having an acceptable likelihood of compatibility with the landlord.

In another aspect, the landlord direct component may further include a record keeping aspect to log at least part of communications between the parties and a renter community aspect to facilitate interaction between at least the renter, additional renters, and the landlord.

In another aspect, the platform components may further include a landlord management component including a landlord financial aspect to receive payments from the renter and a maintenance request aspect to receive a maintenance request for the real property unit.

In another aspect, the landlord management component may further include a landlord-vendor management aspect to request service from a vendor, manage costs to the vendor, and/or log interactions with the vendor.

In another aspect, the platform components may further include a communication component to facilitate interactions between the parties and organize the interactions, the interactions being recordable by the communication component. The broker-assisted component may operate with the communication component to facilitate communication between the parties and the agent.

In another aspect, a tenant exchange may be included to transact rights to a tenant of the transactional relationship.

Additionally, the disclosure may feature a network-leveraged system for facilitating a real property transaction. The system may include a database, platform components, and an interface. The database may be accessible via a network to store and communicate data relating to a transactional relationship and rules for determining a likelihood of compatibility between parties including a renter and a landlord. The platform components may be communicably connected to the database to analyze and manipulate the data. The platform components may include a renter component, a matching component, a communication component, a landlord direct component, and a landlord management component. The renter component may assemble a renter profile including renter information and analyze at least part of the renter profile to derive a renter score for association with the renter, the renter score being includable by the renter profile. The matching component may compare at least part of the renter profile to the rules to determine whether the likelihood of compatibility with a landlord requirement relative to a real property unit meets a matching threshold, and matching the renter and the landlord for which the matching threshold is met. The communication component may facilitate interactions between the parties and organize the interactions, the interactions being recordable by the communication component. The landlord direct component may include a renter search aspect to locate the renter prospective to engage in the transactional relationship relative to the real property unit, the renter being filterable by the renter score. The landlord direct component may communicate with the matching component to connect the renter having an acceptable likelihood of compatibility with the landlord. The landlord management component may include a landlord financial aspect to receive payments from the renter; a maintenance request aspect to receive a maintenance request for the real property unit; and a landlord-vendor management aspect to request service from a vendor, manage costs to the vendor, and/or log interactions with the vendor. The interface may be accessible to interact with the data and at least one of the platform components. A token exchange aspect may be included to coordinate sharing of at least part of the renter profile from the renter to the landlord, the renter granting access to an authorization token for the landlord of the real property unit for consideration for the transactional relationship, and wherein the authorization token is revocable; and

In another aspect, the landlord direct component may further include a record keeping aspect to log at least part of communications between the parties and a renter community aspect to facilitate interaction between at least the renter, additional renters, and the landlord. The renter score may be determined from analyzing renter qualification factors including an income status, a family size status, a creditworthiness status, and a regulatory restriction status.

In another aspect, the platform component may additionally include a broker-assisted component to assist an agent with the transactional relationship including an agent renter CRM aspect, a renter qualification aspect, and a commission protection aspect. The agent renter CRM aspect may at least partially automate tasks related to the transactional relationship. The renter qualification aspect may work with the matching component to substantially identify the renter with the likelihood of compatibility for the landlord with the real property unit in consideration for the transactional relationship. The commission protection aspect may include an escrow to mitigate an attempt by the parties to bypass the agent. The lead marketplace component may selectively transact the renter profile. The broker-assisted component may operate with the communication component to facilitate the communications between the parties and the agent.

In another aspect, a guaranteed rental income protection may be provided to assure financial stability in the transactional relationship. The rules may include a threshold of eligibility for the guaranteed rental income protection. The guaranteed rental income protection may be selectively offered for the transactional relationship that meets a threshold of eligibility. The guaranteed rental income protection may be marketable as a financial instrument.

Additionally, the disclosure may feature a method of facilitating a real property transaction via a network-leveraged system. The method may include (a) communicating data and rules stored in a database accessible via a network by platform components, the data relating to a transactional relationship, and the rules being at least for determining a likelihood of compatibility between parties including a renter and a landlord. The method may also include (b) assembling a renter profile including renter information by a renter component and analyze at least part of the renter profile to derive a renter score for association with the renter, the renter score being includable by the renter profile. Additionally, the method may include (c) comparing at least part of the renter profile to the rules by a matching component to determine whether the likelihood of compatibility with a landlord requirement relative to a real property unit meets a matching threshold. The method may include (d) matching the renter and the landlord for which the matching threshold is met. Furthermore, the method may include (e) assuring financial stability in the transactional relationship via a guaranteed rental income protection. The rules may include a threshold of eligibility for the guaranteed rental income protection. The guaranteed rental income protection may be selectively offered for the transactional relationship that meets a threshold of eligibility. The system may include an interface accessible to interact with the data and at least one of the platform components. A token exchange aspect may be included to coordinate sharing of at least part of the renter profile from the renter to the landlord, the renter granting access to an authorization token for the landlord of the real property unit for consideration for the transactional relationship, and wherein the authorization token is revocable. The guaranteed rental income protection may be marketable as a financial instrument.

In another aspect, the method may include (f) assisting an agent with the transactional relationship by a broker-assisted component, further including (i) at least partially automating tasks related to the transactional relationship and (ii) operating with the matching component to substantially identify the renter with the likelihood of compatibility for the landlord with the real property unit in consideration for the transactional relationship.

In another aspect, the method may include (g) assisting a landlord with the transactional relationship by a landlord direct component including (i) locating the renter prospective to engage in the transactional relationship relative to the real property unit, the renter being filterable by the renter score, and (ii) communicating with the matching component to connect the renter having an acceptable likelihood of compatibility with the landlord. The system may include a landlord management component including a landlord financial aspect to receive payments from the renter; a maintenance request aspect to receive a maintenance request for the real property unit; and a landlord-vendor management aspect to request service from a vendor, manage costs to the vendor, and/or log interactions with the vendor.

Terms and expressions used throughout this disclosure are to be interpreted broadly. Terms are intended to be understood respective to the definitions provided by this specification. Technical dictionaries and common meanings understood within the applicable art are intended to supplement these definitions. In instances where no suitable definition can be determined from the specification or technical dictionaries, such terms should be understood according to their plain and common meaning. However, any definitions provided by the specification will govern above all other sources.

Various objects, features, aspects, and advantages described by this disclosure will become more apparent from the following detailed description, along with the accompanying drawings in which like numerals represent like components.

### BRIEF DESCRIPTION OF THE DRAWINGS

FIG. 1 is a block diagram view of an illustrative transaction assistance system, according to an embodiment of this disclosure.

FIG. 2 is a block diagram view of an illustrative computerized device, according to an embodiment of this disclosure.

FIG. 3 is a flowchart view of an agent management operation, according to an embodiment of this disclosure.

FIG. 4 is a flowchart view of a lead pool transaction aspect of the agent management operation, according to an embodiment of this disclosure.

FIG. 5 is a flowchart view of an applicant management aspect of the agent management operation, according to an embodiment of this disclosure.

FIG. 6 is a flowchart view of a team management aspect of the agent management operation, according to an embodiment of this disclosure.

FIG. 7 is a flowchart view of a landlord direct operation, according to an embodiment of this disclosure.

FIG. 8 is a flowchart view of a landlord management operation, according to an embodiment of this disclosure.

FIG. 9 is a flowchart view of a renter operation, according to an embodiment of this disclosure.

### DETAILED DESCRIPTION

The following disclosure is provided to describe various embodiments of a network-leveraged real estate transaction assistance system. Skilled artisans will appreciate additional embodiments and uses of the present invention that extend beyond the examples of this disclosure. Terms included by any claim are to be interpreted as defined within this disclosure. Singular forms should be read to contemplate and disclose plural alternatives. Similarly, plural forms should be read to contemplate and disclose singular alternatives. Conjunctions should be read as inclusive except where stated otherwise.

Expressions such as “at least one of A, B, and C” should be read to permit any of A, B, or C singularly or in combination with the remaining elements. Additionally, such groups may include multiple instances of one or more element in that group, which may be included with other elements of the group. All numbers, measurements, and values are given as approximations unless expressly stated otherwise.

Various aspects of the present disclosure will now be described in detail, without limitation. In the following disclosure, a network-leveraged real estate transaction assistance system will be discussed. Those of skill in the art will appreciate alternative labeling of the network-leveraged real estate transaction assistance system as a rental platform, real estate and rental facilitation system, real estate backed financial system, transaction system, real estate focused social media and review system, property management software, real estate sales force and team management system, substantially full service renter and broker facilitation system, real estate vendor management system, substantially automated real estate transaction services platform, quotient-based transaction services and electronic registry, substantially full service landlord and tenant system, property rental matching and application platform, landlord management system, the invention, or other similar names. Similarly, those of skill in the art will appreciate alternative labeling of the network-leveraged real estate transaction assistance system as a property rental facilitating process, real estate coordinating and communicating method, renter analysis and matching operation, method, operation, the invention, or other similar names. Skilled readers should not view the inclusion of any alternative labels as limiting in any way.

Some common definitions will be used throughout this disclosure, which will control over all other sources. Real property unit, or alternatively unit, is a property available for rent or currently rented. Transactional relationship is a rental agreement, lease, or optionally real property purchase agreement. To transact includes buying, selling, trading, transferring, and other transactional activities. Party includes at least renters and landlords. Renter is a party looking for a rental unit, not yet in a transactional relationship. Tenant is a person in a rental agreement with landlord for a unit. Landlord owns at least one unit to be filled by a renter, or has filled a unit with a tenant. In applications relating the sale of real property, the landlord term may be substituted with seller and the renter term may be substituted with buyer. An agent may facilitate matching a renter with a landlord with intent that renter will become a tenant of the landlord's unit. Agents may be affiliated with a broker. User includes all parties and others that may use the platform, including renter, tenant, landlord, broker, agent, and other entity. Worked lead refers to a potential renter or applicant that has progressed through at least part of the registration and approval process, which may include qualifying for a level real property prior to submitting an application.

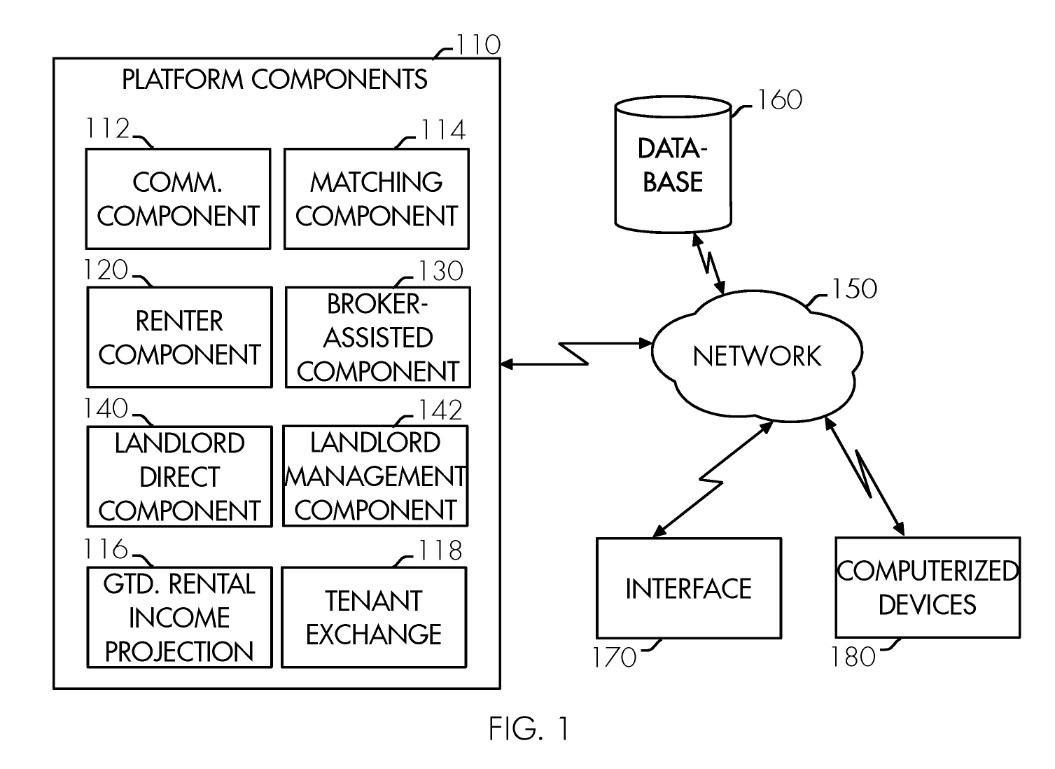

Referring now to FIGS. 1-9, the network-leveraged real estate transaction assistance system will now be discussed in more detail. The network-leveraged real estate transaction assistance system may include a property rental and real estate transaction assistance platform, database, platform components, renter component, matching component, communication component, broker-assisted component, landlord direct component, landlord management component, lead marketplace component, guaranteed rental income protection, renter profile validation aspect, tenant exchange, and additional components and aspects that will be discussed in greater detail below. In some embodiments, the renter component may include the matching component. The network-leveraged real estate transaction assistance system may operate one or more of these components interactively with other components to facilitating matching, engaging, contracting, and communicating between parties to a real estate and/or property rental transaction by a network-leveraged system.

The property rental and real estate transaction assistance platform will now be discussed in greater detail. FIGS. 1-9 highlight examples of the property rental and real estate transaction assistance platform, which may also be shown in other figures. Data may be shared among components, the database, and other aspects of the platform.

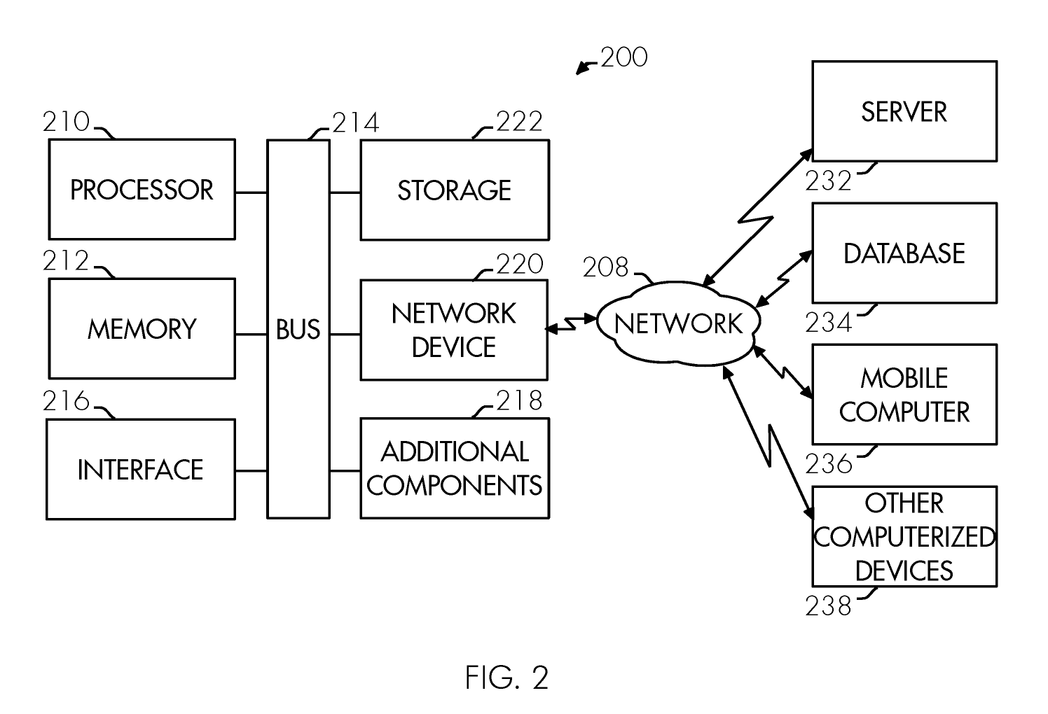

The database will now be discussed in greater detail. FIGS. 1-2 highlight examples of the database, which may also be shown in other figures. Data may be storable in one or more connected databases 160. The databases 160 may be connected via a network 150, for example, the Internet. Data may be accessible from the database 160 by one or more of the platform components 110, an additional database, computerized device 180 operating one or more aspects of this disclosure, an interface 170 facilitating interaction with the database 160, and/or other points of access.

The database 160 may include rules to affect operation of the connected platform components 110. For example, the database may include rules to determine whether a renter and a landlord or a tenant and landlord have a sufficient likelihood of compatibility to suggest the parties be matched. In another example, the rules may be used to analyze data and derive a comparative metric, such as a renter score. Additional examples of rules will be provided throughout this disclosure. Furthermore, those of skill in the art will appreciate even more rules that could be included by the database, without limitation.

The interface will now be discussed in greater detail. FIG. 1 highlights examples of the interface, which may also be shown in other figures. The interface 170 may provide functionality to a user to access, interact, modify, and otherwise benefit from data stored in the database 160 and/or manipulated by one or more of the platform components 110. The interface 170 may be operable by a computerized device 180, for example, a computer or a mobile computing device. Illustrative computerized devices are discussed in greater detail below.

The platform components will now be discussed in greater detail. FIGS. 1 and 3-9 highlight examples of the platform components, which may also be shown in other figures. The platform components 110 may interact with the database 160 to access and manipulate data. The platform components 110 may connect to the database 160 via a network 150, for example, the Internet. A user may interact with the platform components 110 using one or more aspects of the interface 170. The platform components may include a communication component 112, matching component 114, guaranteed renter income projection 116, tenant exchange 118, renter component 120, broker-assisted component 130, landlord direct component 140, landlord management component 142, tenant community social and commerce component, and/or additional components and aspects that would be appreciated by a person of skill in the art after having the benefit of this disclosure. The tenant community and renter community may share features and membership, partially share features and membership, and/or provide discrete features and membership. Examples of the components provided by the platform will be discussed in greater detail below.

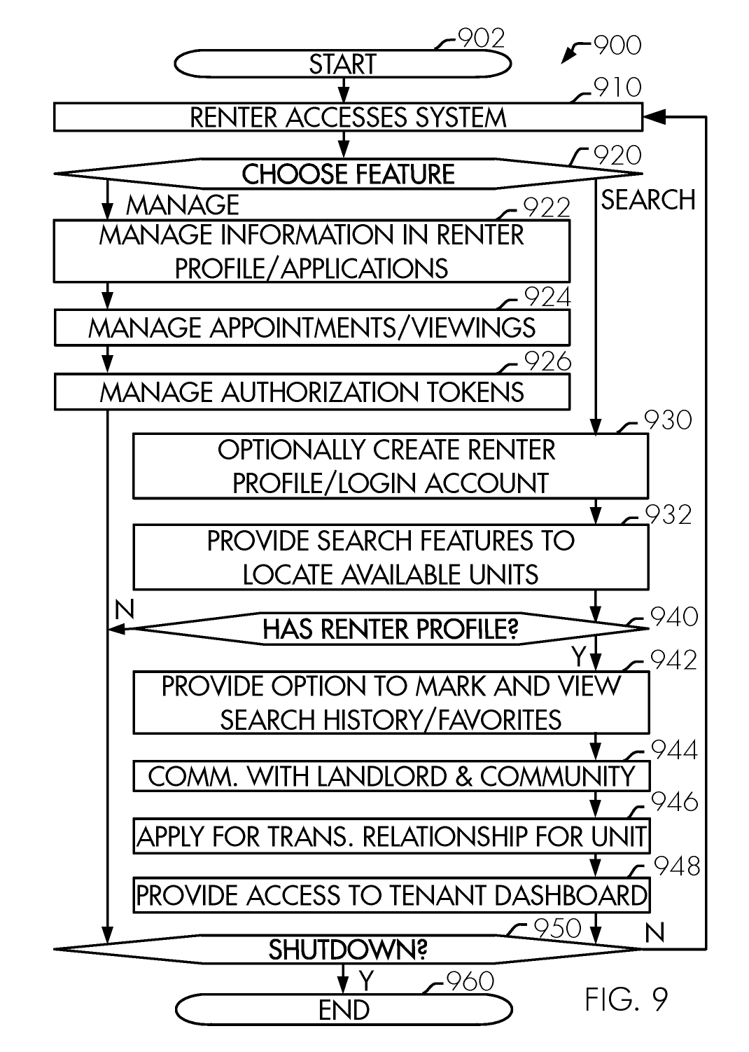

The renter component will now be discussed in greater detail. FIGS. 1 and 9 highlight examples of the renter component, which may also be shown in other figures. In some embodiments, the renter component may include the matching component. The renter component 120 may include various aspects to assist a renter using the platform of this disclosure. For example, the renter component 120 may include a renter profile, renter score, renter profile validation aspect, rent payment history, reviews, ratings, time accumulated in system, and other aspects.

The renter component 120 may be called once a renter initiates/reinitiates the service provided by the platform. For example, a renter may use a phone or computer access the renter component via call, text, or access of a portion of the interface. If the renter accesses the interface 170, such as on a webpage or advertiser landing page, the renter may provide information useful for performing the search. For example, the renter may provide personal profile information, search criteria, or other information to substantially simultaneously register and be matched to apartment vacancies meeting their initial search criteria. Forms may be provided to receive the information from the renter.

To apply and be considered for the apartment, the renter may be instructed to complete their application, screening information, upload documents, verifications, and/or optionally get a guaranteed rental income protection (GRIP) pre-approval letter. These steps may be performed from a renter's customer login page of the interface. If the renter does not pass the automated review process, the renter may update and/or resubmit information for subsequent review.

An illustrative renter onboarding aspect of the renter component will now be discussed. Renters can onboard by accessing interface pages shared with a landlord direct component and/or broker-assisted component, which will be discussed in greater detail below. Alternatively, renters may onboard by calling and/or texting an advertised phone number to receive an address, such as via a text message link, to input initial search criteria via the interface. Without associating the search with a renter profile, the renter may be restricted to entering basic search information. From this aspect of the interface, the renter may choose to search for units listed directly by landlords via the landlord direct component or broker-assisted units via the broker-assisted component 120.

At least part of the renter information associated with the renter may be analyzed prior to granting access to directly engage landlords. The renter may be requested to complete a screening questionnaire to assemble data for the next stage of the process and/or until enough data is collected to establish the initial renter score. Requested information may include income, family size, creditworthiness, regulatory restrictions, references, rental history, and other information. Additional information may be requested if needed, for example, to validate a renter's assertions. Subsequently, the renter may complete an application form and service agreement, upload relevant documents, submit employment and rental verification if appropriate, search apartment listings, comment on erroneous listing information, vote/comment on other user suggested listing changes, and/or otherwise interact with the features provided by the renter component.

The renter may contact landlords or brokers, respective to the path selected by the renter, review and rate their experience, and/or invite landlords to view their renter profile. Renters may also apply to be awarded a GRIP certificate for offer to their chosen landlords. Including a granted GRIP certificate may enhance a rental application by assuring financial security. Guaranteed rental income protection (GRIP) may give renters an advantage over other applicants and give the landlord piece of mind.

Some renters applying may not be qualified. Higher risk applicants may not instantly qualify under the renter component process and may default to the broker-assisted process for additional assistance. Brokers using the broker-assisted system may interact with the broker-assisted component for applicant process support. The broker-assisted component may operate substantially in parallel with the landlord direct component, allowing renters to toggle between these components substantially seamlessly. The platform may share data and previous work stored in the database to the various platform components.

If the renter is disqualified from accessing the landlord direct component, the renter may be substantially automatically sent notice of disqualification and directed to proceed through the broker-assisted process.

The matching component will now be discussed in greater detail. FIGS. 1 and 3-9 highlight examples of the matching component, which may also be shown in other figures. In some embodiments, the renter component may include the matching component. The matching component 114 may compare at least part of a renter profile to available listings to determine a likelihood of compliance with rules associated with the listed unit. The matching component 114 may consider renter information associated with the renter profile, renter score, whether a GRIP certificate was granted, reviews, history, governmental or regulatory restrictions, rules associated with the unit, occupancy limits, pets, rent, income-to-rent ratios, and other renter information. Governmental and regulatory restrictions may include sex offender status, whether the renter needs a home office, pet breed, and other restrictions.

The renter score will now be discussed. The renter score may provide renters and landlords with transparency and lead to a faster process by providing a reliable measure of a renter's riskiness, based on factors commonly reviewed by landlords. Those factors may extend far beyond credit line payment history reporting offered by a FICO credit report, especially since FICO reports do not reflect rent payments. Since rent payment is often the largest expense for a renter, its payment performance history can forecast future rent payment performance. Additionally, renter behavior regarding their landlord, landlord's staff and contractors, neighbors, and a renter's maintenance history can affect the reliability and risks associated with the renter. For example, a renter that pays on-time but spends all night aggravating his neighbors is just as likely to get evicted as if that renter didn't pay rent. In another example, a renter that continuously damages the unit, deals drugs from the unit, or behaves in a manner that makes neighboring units unattractive to future tenants may decrease the marketability of that renter. Therefore, the renter score provided by this disclosure advantageously provides a substantially total summation of the rentability of an individual.

To determine a renter score, the renter may be provided a renter questionnaire. Responses may be analyzed to determine a renter score for the renter. The renter score may be associated with the renter profile of the renter. The renter score may be modifiable upon analysis of subsequently received information, a change in circumstance for the renter, and/or through other actions taken by the renter. From the renter first completing an initial search to exiting a tenant lease and moving out of a landlord's unit, the platform of this disclosure may track, accumulate, aggregate, and calculate data, reviews, and ratings made by the renter and connected parties.

Renter score may be affected by rental payment history. The platform may provide an interface for electronic payment of rent, use of which may be tracked and may affect a renter score. If payment is received outside of the platform, it can be recorded by a renter/tenant and/or landlord on their respective logins. If a rent payment recordation entered by the renter and landlord mirrors several factors, for example, paid amount, payment date, and/or form of payment, or if the payment information is confirmed to be true by the reviewing party, the rent payment may be verified as likely accurate. A rent payment receipt may also be uploaded for safekeeping and future reference in case of questions or dispute. Recordation may also affect the renter score and may allow renter to enjoy continuity of service. The renter score may also increase in value as experiential data builds to benefit the next consecutive lease.

The renter score may be derived from, but is not limited to, some or all of the following: user data from forms and supplied documents, renter/landlord/vendor/neighbor interaction and ratings, the search (interview, negotiation, lease signing), tenancy (renter history, payment performance, maintenance demands, community page peer reviews, reviews about/by landlord, etc.), exit (apartment condition, did tenant leave in a timely manner, was departure pleasant, was there a balanced owing, where there legal fees or contested amounts, etc.), and/or other factors. Rating and review data may be organized, calculated, weighed and/or incorporated with renter's other data to affect the renter score.

Rating and review features may be available and used to rate participants (renters, vendors, landlords) during maintenance issue. Ratings relating to landlords and/or vendors may also be considered by the renter score, landlord scores, and vendor scores. For example, negative remarks by a vendor with a low vendor score may have less weight than a vendor with a high vendor score. These scores may be shared to provide transparency on possible outcomes of future business engagements, deals, promotions, access to services and more. Ratings and reviews made relating to renters may affect the renter score of the renter/tenant. Renters can rate virtually everyone and every service and product they interact with. These ratings and reviews, created by and received by renters, may be aggregated into the renter score, which may consider/use for/in behavioral analytics and predictive modeling. Users who are consistently negative may have reduced impact on businesses, vendors, landlords, and/or tenants they rate.

The renter score may be used to determine how much a renter will pay in service cost, rent cost, GRIP plan cost and duration, renter discounts and incentives, and more. Rewards may be awarded to renters who have a low risk renter score, allowing renters/tenants to earn discounts and enjoy goods and services at reduced rates. Renter score, which may be interchangeable with a tenant score, can also be used to issue lines of credit and other financial instruments. GRIP eligibility may indicate an applicant has met risk guidelines. Supplemental Information may be necessary from the renter to keep GRIP eligibility. GRIP eligible renters/tenants may be provided a GRIP card to get an instant approval to rent, make purchases, and get access to discounts and promotions. Tenants may also qualify for GRIP to ensure lease continuation resigning, or to qualify for rent reduction, for example.

Time spent using the platform may create intrinsic value in the renter score and may facilitate iterative accumulation and recalculation of relevant data. Renter's/tenant's ratings and reviews, timely rent payment history, frequency and severity of property damage, other factors attributing to income, cost, and quiet enjoyment of other tenants may be factored into the renter score. The renter score may also be used to establish credit profiles and access to financial services and instruments offered to a renter. Financial instruments may be offered through the platform, which may be backed by another entity. The financial instrument aspects may offer a variety of debt instruments. Types of credit and amount of credit may be determined by the renter score, which may be indicative of experiential transaction data and behavioral analytics.

Risk modeling provided by the platform may additionally expedite renter applicant rental process by providing rental income protection for landlords. The risk modeling may additionally provide a tenant exchange where lease contract transaction can be packaged and sold as short-term securities on global exchanges. The risk modeling may create renter based credit system to underwrite financial instruments for renters, tenants, landlords, agents, vendors, and/or others. The risk modeling may additionally improve the odds for an enjoyable rental experience for the parties, benefiting from reduced time and cost of a rental process.

A renter may advantageously monetize their renter score by receiving promotions and discounts on goods, services, rent, credit lines, credit cards, other financial instruments, financing options and more. These offerings may be based on the renter score associated with the renter.

Landlord profiles will now be discussed. The matching component may also analyze a landlord profile, which may include an associated landlord score. A landlord profile may include background data, user ratings, risk score, payment score, reviews, and the renter score of the landlord's tenants. Since the landlords' financial stability is relative to the financial stability of the landlord's tenants, landlords with more stable tenants may be given a more favorable landlord score. Landlords with a sufficient landlord score may be provided more opportunities for promotions and discounts on goods, services, credit lines, credit cards, financial instruments, financing options, and more. The landlord may additionally be associated with profile continuity to incorporate user reviews about landlord performance for future use. Landlord reviews about renter performance, number, severity, and frequency of maintenance issues and speed of resolution, and other factors may assist with GRIP issuance to renters and landlords.

GRIP benefits to landlords may include access to alternative options to finance commercial property, other than to be forced to borrow consecutive balloon loans, which are typically costly and disadvantageous to landlords due to the manner with which balloon loans operate. Leveraging GRIP, landlords will be able to provide confidence and stability to lenders, which shows rents are backed and that resulting income stability may warrant lower costs and alternative financing that may be equal to or better than options provided to residential homeowners.

Predictive behavioral compatibility (PBC) models may affect analysis to determine a likelihood of compatibility between a tenant and a landlord, and tenant and tenant. Comparative attributes of the tenant and the landlord may be considered in the PBC analysis and may influence the issuance of GRIP. The PBC models may be used to determine landlords/renter compatibility, reduce lease default, and increase satisfaction in renter/landlord business transaction relationship. Reviews from tenant, vendor, and landlord may be used in PBC modeling for compatibility analysis and actuarial purposes. Management staff and maintenance staff that administer over, or interact with, tenants may be rated, reviewed, weighted, and/or factored into the PBC model.

The communication component will now be discussed in greater detail. FIGS. 1 and 3-9 highlight examples of the communication component, which may also be shown in other figures. The communication component 112 may facilitate communication among users of the platform of this disclosure. The communication component 112 may provide VOIP calling, virtual assistant services, SMS messenger applications, and other communication features for use with the platform of this disclosure. The communication component 112 may be used for advertising, notifications, announcements, and user purchases. The communication component 112 may facilitate connection and management of multiple phone numbers at the same time, such as through a messenger, to provide incoming and outgoing VOIP and SMS communication from one or more phone numbers in one simple to use dashboard aspect of the interface.

The communication component 112 may provide many-to-one interface features and provide access to many phone numbers using one interface. This may be especially advantageous for call centers or brokerage offices where many incoming and outgoing calls and/or text messages need to be managed from multiple agent/company owned phone numbers. This may be different from having one phone number and multiple extensions. There may advantageously be no additional hardware installation required. The communication component may additionally interface with a virtual assistant, allowing users to customize communications, set recorded messages, dial prompts, office hours, incoming call and SMS filters, automated text and voice replies, call forwards, and other features.

The broker-assisted component will now be discussed in greater detail. FIGS. 1 and 3-6 highlight examples of the broker-assisted component, which may also be shown in other figures. The broker-assisted component 130 may include various aspects to facilitate interaction between an agent and one or more parties to a real property transaction. The aspects may include an agent renter CRM aspect, renter qualification aspect, token exchange aspect, commission protection aspect, team module, leads modules, find broker module, find team module, sell team module, manage hierarchy module, and other aspects and features that will be appreciated by a person of skill in the art after having the benefit of this disclosure.

Sharing of CRM data to subclasses will now be discussed. Renters become tenants when they occupy property and are in a transactional relationship with the landlord, for example, a lease. The broker-assisted component 130 may facilitate sharing data between agents, renters, tenants, landlords, vendors, and/or other entities. Star reviews created by a renter, tenant and/or agent about a landlord may be shared with the renter community (RCRM), the tenant community (TCRM), and the agent community (ACRM). Additionally, star reviews created by a landlord about renter/tenant, agent and/or vendor may be shared with the landlord community (LCRM). Star reviews created by a vendor about tenant and/or landlord may be shared with the vendor community (VCRM). Star ratings created by renters and tenants about agents, landlords and/or vendors may be shared in the renter community (RCRM) and tenant community (TCRM), respectively. Reviewing users may additionally add attachments like images, audio and video files, and document files, GIFs, and other formats to further communicate through the review, rating, and social media CRM.

The agent renter CRM aspect will now be discussed. The agent renter CRM aspect may advantageously automate a substantial amount of repetitive renter-related communication, processing, organization, real property showing, landlord matching, negotiating, and lease signing activities so agents can focus on selling and marketing. Automating may streamline coordination of renters and landlords, saving parties time and money by only preparing/explaining renter profile to deliver and explain to a landlord, arranging property viewings, requesting fees, explaining the rental process, explaining renter rights and obligations, assisting with negotiation and lease signing, providing experienced information about local areas and markets, and providing assistance with other needs of the rental process. This may be accomplished at least in part by matching parties with an acceptable likelihood of compatibility.

The aspect may feature automated renter process categorization. Once a renter calls or fills out the initial input form, the system may manage and substantially automatically categorize renter leads based on whether the renter qualifies and how far the renter gets in the process, with progress stages including the renter starting with completing the intake form, screening questionnaire, document upload, form completion and verification, viewing listing information, negotiation, and lease signing.

The renter qualification aspect will now be discussed in greater detail. The broker-assisted component may communicate with the matching component to substantially automatically determine if a renter's search criteria are realistic, for example, by comparing renter-entered search elements with at least part of the renter information included by the associated renter profile. If a renter's search criteria and renter profile is at least within the lower average minimum threshold of compatibility between parties, the search may have a reasonable chance of producing a successful outcome and may proceed. The renter may be granted access to additional features of the platform. If this threshold is not met, the renter may be notified to review and correct the issues which prohibit access to the rest of the process. The system may additionally give renters the opportunity to resolve issues that resulted in the rejection of the renters' search criteria.

Once access is granted to continue, the system may guide the renter substantially step-by-step, simplifying the search and application process by splitting up tasks to not overwhelm the renter. As the renter moves through the process, the system may categorize the renter according to their progression in the overall sequence. These process categories may trigger programmed events and automated communication, as well as sequence other automated functions. These sequences may communicate and coordinate renter efforts with those of their assigned agent and landlord to help everyone navigate the process with far less effort and confusion.

Once the screening process is done, a renter's initial risk score may be established and the renter may be informed of a service cost. Once the renter pays the initial fee, if requested, any money collected by the system or directly by an agent or agent's office may be accounted in the accounting function accessible via the user account. Information delivered to the renter about their cost and renter score may also be made accessible by the agent. The system may receive renter inputs to perform the screening, risk assessment, profile building, property matching, and respective renter's cost/payments to use the service, if any.

The broker-assisted component may send automated renter updates, invitations, and reminders by email, app messenger, text, and/or other communication media according to where the renter is in the process and based on what messages the system received and/or sent previously. Automated communications techniques and content may be customizable in the interface features accessible to the agent/managing broker/brokerage.

An auto-criteria matching process may be provided to match the renter's search profile to any available rental unit based on the renter's provided search criteria. Once matched, the system may alert a renter/agent/landlord and may allow a renter and landlord to schedule a viewing or perform a virtual viewing. In similar instances, a managing broker acting as an agent to a renter/tenant/landlord is also considered an agent. Viewing may occur with or without the agent, at the property or virtually. Final negotiations for lease and tenancy terms may be between the renter and landlord. Viewing experiences may be rated by renter and landlord. Renters may invite participating and nonparticipating landlords to view the renter applicant's documents, verifications, credit report, renter score, renter profile, and GRIP if any offered. Once the renter and landlord are matched, the renter can invite landlords to view the renter's profile and landlord can consent to interview or reject the renter from the renter profile associated with the renter.

If the landlord consents to interview a renter, then the renter can interview with the landlord to view the unit. Landlords may communicate with renters through the platform to coordinate viewings, answer questions about the unit, or otherwise grow the relationship. The renter and landlord may also agree to sign a lease for the real property unit. If the renter and landlord agree to sign the lease, the landlord can produce a physical lease or a renter and landlord can sign an electronic lease via the renter portal. Once lease is signed, the renter becomes a tenant and may join the renter community, if provided. If rejected, the renter may attempt to incentivize the landlord by counteroffering with, for example, prepayments of rent, extra security deposit, move-in fee, or GRIP policy. A landlord may also attempt to assist the renter by selling/referring renter information on a lead pool if permitted by the renter, so that the renter may be contacted by agents and/or other landlords interested in renting or assisting the renter with the renter's search.

The commission protection aspect will now be discussed in greater detail. Renters may be required to pay agent upfront fees to start the search and/or create/improve a renter profile. To incentivize rental of lower cost-units, at least some of the fees charged may be provided as a service fee, for example as an equivalent of one month's rent or an otherwise defined flat fee. Additionally, the agent may charge other fees to be held for/in and agent/brokerage escrow, for example, upon notification of the landlord's acceptance of the renter's qualifications and prior to the renter receiving landlord's contact info or property address. Related terms of service may be outlined in the renter's service agreement. Once the agent obtains a landlord's acceptance of the profile and landlord makes an offer to lease an apartment meeting the renter's criteria, the agent may get paid regardless of whether the transaction completes with a lease signing. The agent's scope of work may be reduced only to obtaining an offer for the renter based on renter's criteria and then introducing the renter and landlord to each other.

The GRIP plan cost aspect will now be discussed in greater detail. A renter and/or landlord may be required to pay to use GRIP. Payments for GRIP may require an upfront and/or recurring fee to start, maintain, or otherwise continue policy coverage. Policy coverage may include a deductible portion due upon a policy claim. GRIP may include an insurance policy underwritten and/or backed financially. GRIP may be issued as an insurance product and/or as a corporate lease. GRIP may be created by a cooperative of renters, cooperative of landlords, cooperative of investors, and/or a combination of the above. GRIP payment may be fixed and/or variable, for example, based on a percentage of rent and/or total GRIP liability. GRIP may be issued for a definable coverage duration and/or total coverage amount. GRIP may be conditionally offered and conditionally provided/honored. GRIP may be bought, sold, leveraged, bundled, traded, transferred, and/or factored.

Co-application access features will now be discussed. If a renter has co-applicants, the renter can grant and revoke access to his co-applicants. Once invited, co-applicants may be entitled to access substantially all the same customer features as the applicant. However, co-applicants may have no user admin rights to grant or revoke access privileges of the applicant. Applicant may reject co-applicants and co-applicants/applicants may also reject being co-applicants and become applicants themselves and invite other consumers or current applicants to become co-applicants. A co-applicant may be restricted from also having co-applicants.

Text messaging communication will now be discussed. Text messages may be received by the system that are not associated to any existing customer record, which may be categorized, sent an initial auto-reply, and if a follow up text is sent by the renter, categorized and answered with more specificity to encourage the renter to begin the process through the system. Conversations which are unanswered by the renter may also be flagged for the agent to review. A message can also be sent on a timer by selecting on which day/time a message will be sent. Message sending can be cancelled prior to sending. Once the renter's intake form is completed, a renter record may be created and the record may convert from an unassociated account to an associated account. Incoming renter text messages may also be received by one or more phone numbers associated with a renter profile. Text messages sent by the renter may be collected in the renter profile. The platform may collect and distribute text messages from one or more company/agent owned phone numbers, to the appropriate renter account and organize those incoming/outgoing messages chronologically in a single conversation thread viewable by the agent and may also be viewable by the renter/tenant.

Traditionally, conversation threads may be grouped by subject line and in chronological order. The messenger features of the platform may organize long messages and text messages chronologically, not by subject line. Long and text messages may be grouped by date. Long message, text messages, documents, forms, and document storage may also be organized in one application, accessible from a page of the interface. Renter records may be associated with long message, text messages, documents, forms, applications, agreements, receipts, GRIP, payment records, rent payment records, reviews, ratings, customer/agent/system logs, and document storage may also be organized in a customer record, risk and cost profiles, fillable e-forms, emails and messenger services, accounting, system, event log registry, agent notes and more, all available from the interface available to the agent. This advantageously reduces or eliminates the need for users to rely on multiple software applications.

Renter may easily send employment and rental verification fillable e-forms to the landlord and employer directly from the renter's login. Form fields can be designated as required, preventing submission of incomplete information. Forms may be stamped with geo location, IP address, and date/time, and start/end time to show the authenticity and origin of form completion. Forms may not need to be printed, faxed, or scanned to be delivered to the customer or agent. Once employment and rental verification forms are completed, the related forms may be substantially automatically converted to a PDF document or other format, copies may be sent to the landlord/employer, renter, and agent, and a PDF may also be substantially automatically generated and saved to the document uploads section of the renter profile, for example, upon e-form completion.

Once rental data is submitted by the landlord on the rental verification form, it may also send landlord data directly to the landlord database without further input or intervention of a human operator. Saved landlord data may be used by renters in the auto-criteria matching, substantially real-time, and landlord direct process, and by agents in the broker assisted rental process. New landlords may be substantially automatically invited to register with the platform to access system features and renter profiles.

Agent landlord CRM aspects will now be discussed. An agent landlord CRM aspect may be provided to save, find and display landlord, property and unit data, and provide team manager features by substantially automatically delegating work to various team members, such as advertisers or landlord aggregators. This CRM also collects landlord data from various in-house and syndicated sources, such as a rental verification page, renter applications, listing pages, renter's landlord invite and input pages, agent's provided CRM, and other sources that would be appreciated by a person of skill in the art after having the benefit of this disclosure. This CRM may also be kept current by landlords, agents, and renters.

The agent landlord CRM aspects may provide auto-listing features, for example, substantially automatic publishing of listing information to popular rental applications and websites. In one example, listing information for a real property unit may be submitted by the landlord the listing information may then be published on multiple major real estate listing media, proprietary platform media, and other in-house and syndicated products, either by the listing advertiser and/or via API or similar automation. The listing may be substantially instantly made available to the advertising team, on the agent community, and/or the renter community. Marketing/listing agreements may be substantially automatically generated as a PDF and copies sent to the landlord, agent, and brokerage in accordance to local real estate laws. The landlord may be invited to continue registration to access a full feature set on the landlord's dashboard, if a landlord profile has not yet been created.

The aspect may provide a CRM landlord database that allows the agent to create a one-to-many relationship, or where one landlord record can have many real property records and each real property can have many real property rental unit records. The CRM also allows an agent to rate the various landlord data categories, such as, for example, landlord, real property building and real property unit info. The CRM may also offer subscription marketing services to landlord and/or to agent/managing broker/broker to advertise real property information, to keep such at the top of renter/agent search results.

The aspect may provide advanced leasing features. Renters may apply to rent future possible available real property units before the real property units are vacant and advertised on popular websites. These advanced leasing features may give renter and landlord a huge advantage over otherwise similarly situated parties. Landlords can advantageously start reviewing applications and enter into a new lease agreement early, planning a seamless transition from one tenant to another without all the hustle and bustle of dealing with volumes of applicants and without listing and/or marketing the real property unit. Renters can reserve their apartment in advance to reduce the stress of looking for and competing with other renters for an apartment. The advanced leasing features advantageously reward preparedness and proactive thinkers.

Real property unit availability results may be displayed by a date range search. Lease ending and starting dates, expected vacancy dates, move-in/move-out dates, and/or other dates may be stored and made searchable by date range, date category, flag, and/or another variable. Confirmation of the accuracy of these dates may be made by one or more of the parties. Viewing dates may be coordinated by the tenant and/or landlord and open house events may be coordinated using the same calendar system. Move-out may be confirmed by tenant and/or landlord for use by the calendar system.

The aspect may provide data pool features. Landlord, real property, and real property unit data may be synchronized and accessible to agent/renter/tenant/landlord. The data may additionally be made available to listing advertisers, verifiers, agents, and brokers. For listings, listing advertisers may use the data pool to advertise listing data. This listing data may be made accessible to a listing advertiser to publish ads on various listing websites and search engines. Rights for the listing advertiser access may enable listing advertiser to work substantially independently and without direct supervision, communication, or instruction from any team member, manager, agent, broker, or landlord. The listing advertiser may advertise vacant real property units, real property units available to view, and/or real property units becoming available to lease by a lease ending calendar, notice, flag, and/or other indicator. The listing advertiser may have access to statistics data to determine advertising success and conversion rates to track and issue invoices for measurable units of work. This technique of work measurement and tracking may allow advertisers to be paid by performance, which may elevate high performing advertisers and substantially simultaneously help reduce wasteful spending on advertising. Other staff and team members may also work under the same principle, concept, and technology.

The aspect may provide undesirable status tagging, for example, no commission tagging. When an agent encounters a landlord who refuses to work with agents or refuses to pay commission, the agent may mark the landlord record with a tag, for example, a “no commission” tag. Tagging can help categorize landlords based on their taggable statuses, reducing the likelihood that “no commission” landlords get mixed in with a landlord who is tagged as “pays commission,” or landlords that are “unclassified” as whether they pay commission. Landlords may also be tagged to a hot list. For example, an agent wanting to search for a landlord by star rating or by recent real property rental unit conversion from occupied to vacancy, the agent may set filters to retrieve results accordingly.

The aspect may provide regulatory restriction status filtering features. For example, some landlords cannot afford to pass CHA housing inspections to qualify to rent to CHA and/or Section-8 tenants or other rent subsidized tenants. Landlords that qualify and rent to rent-subsidized tenants may be found through such a search filter.

The aspect may provide additional regulatory restriction status filtering features. For example, the aspect may provide a sex offender property search feature. For sex offenders, it may be difficult to find a place to live due to governmental and regulatory restrictions. For example, there are specific areas where sex offenders cannot live. In Illinois, a sex offender cannot live within 500 feet of a school, daycare, or park which has a playground. Conversely, unrestricted renters may desire to live in a neighborhood restricted to sex offenders or with a minimal number of sex offenders nearby. Furthermore, some landlords prefer not to rent to sex offenders or other restricted renters.

The platform may provide a unique polygon map and data clustering allows renters to search for rental opportunities inside or outside of 500-foot bubble around property, schools, daycares, or park. This advantageous feature may provide renters and landlords tools to consider these regulatory restrictions, a feature that is not known to exist in prior platforms. The search map of this disclosure and filter may assist sex offenders and people who want to avoid sex offender friendly zones find a place to live.

A city block, urban block, or simply block is a central element of urban planning and urban design. A city block is the smallest area that is surrounded by street. Tenant satisfaction for their block/immediate/local area may identify to prospective renters which blocks to avoid when trying to avoid loitering, unreported crime, poorly maintained streets, and other conditions. Ratings and reviews may be made available for renters during their search and can be selected to display/factor/filter for this information to limit output or for decision making about where to live.

The aspect may analyze user profiles and categorize landlords for access to certain features. For example, once a phone number from the database is determined to not be a landlord, the phone number may be deleted from an attempted association with a landlord profile. The phone number may also be blacklisted, for example, prohibiting new profiles and records from being created with the restricted number.

Additional categorization may be performed for a same landlord with related property data. If the landlord attempts to use a different phone number for new property data, such as if by creating a new phone number for a unit or property, a new landlord record may not be a created under a new or existing phone number. Instead, the new property and unit record may be associated to an existing landlord profile for the given number. If a user attempts to create a new record with a phone number and for an existing property record, a new landlord record may not be created under a new or existing phone number. Instead, this existing property record may become updated and property unit records may be updated or created if the real property unit record does not exist.

An aspect may be provided to avoid or minimize co-op fees. Using data from the landlord database, agents avoiding paying the multiple listing service (MLS) fee to access real property data and rental listing data. Info on the MLS may be listed by agents. A cooperating fee may be paid to the listing agent. For the current aspect of this disclosure, agents may work directly with landlords, allowing agents to earn double the commission on the same amount of effort and avoid the co-op fee. This new agent to rental property direct process may be called the rental multiple listing service (RMLS).

Agents may assign zip codes to support staff, otherwise referred to as verifiers, on an agent's team. The verifiers may contact landlords without accidentally having other team members call the same landlord record. The agent may restrict access to a verifier, not being required to give all-or-nothing access the entire landlord database to the verifier. This access restriction advantageously increases security and programmatic applications. Records may be displayed one at a time to prevent the wholesale copying of data by the verifiers. Additional technology may be used to prevent the agent's use of select mouse and keyboard features to select and copy page content.

An aspect including the landlord dashboard will now be discussed. Landlords may view and manage renter leads, renter/tenant lists, rental property, renter search criteria, renter/tenant search criteria, real property unit availability, showing calendar, maintenance calendar, lease start/end calendar, rent payment calendar, move-in/out calendar, and other data via the landlord dashboard. The landlord may invite a renter or a tenant renting elsewhere to apply to a current or upcoming listing, browse searchable criteria, forms, chats, records, property maintenance requests, vendors, collect rent, choose rent collection techniques, manage income/expenses/rent payment records, buy/sell/transfer leads, sell real property, manage listing publications on landlord's behalf, manage tenant notices, newsletters, negotiation tools, subscription advertising features, communicate/view progress of late paid collection/process-service/eviction, manage accounting/tax preparation/filing, manage property manager/maintenance/office staff/contractor, and perform other operations. The landlord may register, add, edit, or otherwise modify information for a real property unit. The landlord may also respond to renter/tenant messages and questions via a chat or messaging feature of the landlord dashboard. The landlord may access a lease form, lease record, documents, application forms, ratings, reviews, risk score, GRIP info if any, and other information associated with the landlord or a prospective transactional relationship via the landlord dashboard. Landlord may issue rent discounts or perform as an advertising media for tenants to earn advertising income from companies. Advertising media may be brokered and paid to landlord based on real property location, number and type of renters, rent amounts, renter criteria, and/or tenant ratings/reviews. Landlord may earn an income for providing access to advertisers. Advertising may be included in newsletters, billing statements, periodic updates/announcements, and more. Landlords and tenants can opt in/out. Landlords and tenants can be paid to watch/opt in to receive/send advertising. Rates can be negotiated and brokered through bidding/auction. Monthly subscription may be paid to not receive advertising.

Landlords may add themselves to the platform-connected database for “auto-criteria matching” and/or “auto-listing.” If landlord data exists for a landlord, the landlord may claim the data and edit/update their profile. The landlord may create a new record by registering or completing an online form without needing to register. If a property record exists and/or is claimed by another person, the landlord may upload evidence of ownership to claim the data record to associate with the profile with the correct landlord.

The token exchange aspect will now be discussed. A renter applying to a landlord unit may send the landlord an invitation to authorize the landlord to review a renter profile associated with the renter/tenant. The renter may limit the authorization token with temporary access. The renter/tenant profile may be defined as accessible for a limited period, after which access may expire. Once expired, a landlord with the expired authorization token will not be able to view the renter/tenant profile under the same token unless the profile was/is accepted by landlord. If the token is ignored or rejected, profile access may be terminated under the same token. The landlord may be provided a table in the landlord dashboard showing offers received, which actions were taken, and option to message renters/tenants unless connection to tenant/landlord/renter remains blocked. Access to actual renter/tenant data may not be available if a token is expired, renter/tenant profile is rejected, or the renter/tenant withdraws/cancels/blocks authorization to view the renter profile or contact the renter/tenant.

Lease negotiation and signing aspects will now be discussed. The parties may negotiate and sign the proposed terms of the transactional relationship electronically through a structured application process before a physical or electronic rental agreement or lease is signed. Once the terms are agreed, the parties may sign the lease, beginning the transactional relationship. Rental listing data may be accessed, populated, modified, and analyzed to create a foundation for negotiation. A proposed lease agreement may be populated with listing data once a party decides to send an offer to the other party.

In an example lease negotiation and signing, a renter may click to apply for a unit on the platform. Existing listing data such as availability/lease start date, rent amount, pet policy, any utilities included in the cost of rent, amount of security deposit/move-in fee/pre-paid rent/GRIP, and/or any other terms written into the listing may populate in the electronically fillable lease. Once the draft lease is filled, the sender sends the offer to the receiver. Sender and receiver are interchangeable, depending on which party is sending the lease for review and which party is receiving. In this digital lease, virtually every data field may be editable directly in the attachment or view of a message provided by the platform. Third party signing services or APIs may not be necessary. The lease may substantially automatically save all changes made to it. Once changes are sent, fields changed by the sender may be highlighted for ease of finding/identifying/changing/approving/rejecting by the receiver. Changes may be restricted after lease is signed by all parties to the contract unless mutually agreed.

The lease may be provided as an attachment. In the lease attachment, sections of the lease may contain speech bubbles to identify comments where parties can start a conversation thread on the topic of a commented section. Messages may remain in an outgoing/sent box until there is a response from receiver or until the message is withdrawn by the sender. Response may include, for example and without limitation, accept, reject, counter offer, withdraw, expired, or blocked. Once a response is made, the message may be delivered to the receiver's inbox. Sent/pending requests may be stored in sent/outgoing boxes. A sender of the offer may be provided an option to withdraw the offer at any time before action is taken by the receiver. Deadlines can be set to complete the lease. Failure to timely complete the lease may trigger automatic expiration. Lease expiration warning notices may be provided to receiver and sender. Lease extensions and other changes may be possible under mutual consent of the parties to the lease.

Renters may be provided access to substantially real-time landlord data. Renters may also influence this data by providing feedback for landlord data created by or made available to renters/tenants, such as in the renter/tenant community, is accurate and current. Collectively, the renter/tenant community may review and update current data in substantially real-time by voting on a suggested change/correction until this suggestion replaces current information. Renters may also flag a record for deletion. Flagged records may be reviewed or deleted substantially automatically, depending on circumstance.

In one example, multiple renters/tenants may talk to the same landlord and get information that is contradictory to the information available to the renter/tenant community. This community may update that data to become more accurate. Users may vote to pass a change or reject a change suggested by a renter. Renters/tenants may receive points for suggesting changes that receive favorable votes. In a more specific example, provided without limitation, a unit may be listed at $1000. Other renters/tenants may learn the unit is stated by the landlord to be $1100. A renter/tenant may comment on the rent price setting the suggested price to $1100. Other renters/tenants may confirm that comment by making an affirmative vote. Once a confirmation threshold is reached, this field may become updated to reflect the suggested price of $1100. Renters can likewise vote to decline the suggestion and the field will remain in its originally posted price until an affirmative vote count is met of $1000 or other suggested price. Once a “decline vote” threshold is met, the suggestion may no longer be visible.

The team module will now be discussed. A team module may be provided to facilitate sharing leads among agents. An agent management aspect may be provided for assigning the agent to a managing broker. Those of skill in the art will appreciate that the term agent may vary in definition from state to state and is meant throughout this disclosure to include a licensed and managed representative in a real estate field. The term managing broker is meant throughout this disclosure to include a sponsoring broker, managing partner, brokerage, or licensed manager. A team monitoring aspect may be used to analyze statistics, manage access, association, hierarchy position relative to agent and track data relative to performance of the agent or members of the agent's team/hierarchy. At least part of the data may be associated with the agent. Agents and brokers can find, buy, sell, trade, transfer, and manage team hierarchies. Terms of sale may include restrictions on leads, views, teams, functions, and/or other details.

The virtual team aspect will now be discussed. The virtual team aspect may assist with developing hierarchy teams and leads management. Virtual teams may be used to delegate, segregate work functions, and provide transparency on each work function or customer process. Tracking, collaboration, and management may be performed by stage, by sequence, by functional process segments, or by entirety of a renter process. Agents may see a lead in their hierarchy branch. An agent in one branch may be restricted from seeing another agent's leads of a different hierarchy branch. Agents may be assigned a managing broker in a local team, however, in a virtual team one agent may have a virtually unlimited number of managing brokers associated to report to an agent. Leads and work may flow up from an agent to a virtual managing broker of flow down from an agent to a virtual managing broker or agent. Virtual team hierarchy may deliver lead tracking and process tracking capability to encourage work sharing. Work sharing may benefit the customer and participating member of a hierarchy. Contrary to a local hierarchy, in a virtual hierarchy, not every agent of a branch may have the same managing broker. In a virtual team hierarchy, agent/managing broker participants may be associated and/or disassociated electronically, for example, via the platform.

The team management aspect will now be discussed. In a brokerage hierarchy, a brokerage can team with other brokerages and agents to expand their team hierarchy. Brokerages may see any lead in any of their hierarchy branches. Brokerages in one branch cannot see another brokerage's leads of a different branch. In an agent hierarchy, an agent can have other agents in their team hierarchy. Brokers can be a virtual team member of an agent since the managing broker is likely to have a team of local agents to improve productivity for virtually any agent who become parent of the managing broker. Agents may not manage managing brokers locally, however may manage managing brokers virtually. In some configurations, a local agent cannot become parent of a managing broker. For example, a local agent may be parent to other agents in local and virtual team hierarchy, they may be parent managing brokers in virtual teams, but cannot be parent to a local managing broker. A managing broker may have agents and managing brokers in a local and virtual hierarchy.

Agents may determine local association (local team) vs virtual association (virtual team) during registration. Agents may be requested or required to identify their state and city. If their location is same or within proximity to an office receiving invite, the agent/broker may be classified as local if invite is accepted and if same agent/broker is not already associated locally elsewhere. If the agent/broker is already associated locally, then all other associations may be classified as virtual unless an agent applies with the intent to become a local agent with that brokerage in which case if a new association is made then virtually any open association with a local brokerage may become disassociated. Disassociation may lead to the transfer or abandonment of any open contracts, according to terms previously negotiated between agent and managing broker. An agent may team up with another agent in any level of a hierarchy branch, even an agent under a different managing broker or same or different brokerage or same or different branch. Joining a team hierarchy may be optional. Teams and individuals can disassociate from each other and find new teams to join or remain independent.

Teams, agents, and brokers may search and select a team and/or brokerage according to specialty and what agents, teams, and/or brokerages offer in compensation packages. To attract agents and brokers, compensation packages can outline benefits of joining. Package benefits may be offered by brokerages, brokers, teams, and/or individual members. Packages may provide incentives for individual agents, brokers, brokerages and/or other teams to join a cooperative, collaborative, and teamwork oriented process.

A branch in a hierarchy can be disassociated from a brokerage and/or agent, moved, traded, bought, transferred, and/or sold to another agent, team, or brokerage. Market rate for a team or agent may be based on team size, production, and number/type of assets. The sale may be for the entire hierarchy or for a part of the hierarchy and may include assets/liabilities of the team/hierarchy. Leads owned within that branch or segment which is available for sale may be included or excluded from the sale or reorganization.

A brokerage finder may be provided for an agent to search for and send an invite to join another agent, team, or managing broker. Agents may search for and apply to join another agent to become a team member. Agents may also search for and apply to join an existing team. Agents may search for and apply to join a brokerage and work under a managing broker. In some embodiments, a managing broker may be restricted from sending an invite to join an agent. Brokerage or team finder search may filter by name, location, zip code, reviews, prospective profit, projected volume of business, specialty, skill, experience, reputation, and/or other considerations.

Income calculation may consider volume of business. The calculation may receive input of expected monthly transactions and average gross commission amount per transaction and this triggers the generation of expected income after expenses for any participating agent, team, managing broker, or brokerage. The profit potential may be determined by subtracting cost charged by the agent, team, brokerage in an offered plan. Plan packages may be created and published for agent, managing broker, and team to attract and build and recruit teams and organizations. Teams, plan packages, agents, managing brokers, and brokerages may be rated, reviewed, and commented.

Agents, managing brokers, and brokerages may easily manage any of local team agents, contractors, or employees and virtual teams. Each agent and broker can have their own advertiser, rental marketer, landlord aggregator, contractor and/or office staff, which may be managed from the agent's, broker's, or brokerage's login. The local hire may differ from the virtual team in that local hire contractors and employees may be restricted from association/disassociation electronically. In a local hire, digital links may be omitted for their child/parent to associate/disassociate. In one embodiment of local team relationships, quitting, hiring, and firing may be done with the click of a button.

Freelancers may include contractors and employees that may work for real estate teams, agents, managing brokers, or brokerages and may include individuals such as an advertiser, landlord aggregator, or other available contractor position. Contractors and/or employees may search for and apply to join an agent, agent's team, managing broker, and/or brokerage. A search to find a suitable employer can be performed by name, zip, reviews, or income package offered to contractors. Query results may include, ratings, compensation packages, and information about the managing broker, brokerage and/or team. Freelancers may opt to work exclusively. Teams, agents, managing brokers, or brokerages may place available jobs on freelancer job boards, invite individuals to become freelancers, review bids, hire, accept contracts, manage disputes, establish escrow to pay freelancer, manage freelancers, pay through an interface aspect, rehire and manage payment techniques, disputes, pending and closed contracts, ratings, reviews, reports, statistics, and more.

The team monitoring aspect will now be discussed. Regardless of where the team member originates, by virtual team, or by local team, they can be easily monitored and/or managed in the team manager. Performance may be tracked for agents, brokers, hierarchies, freelancers, contractors, employees, and/or others.

Regarding category statistics and recording, regardless of where the team member originates, by virtual team, or by local team, the team can be easily managed in the team manager. Performance may be tracked. The performance manager may provide easy-to-manage support staff efforts by tracking which and how many record fields are updated, created, deleted, and/or otherwise modified. Tracking may include whole record changes, field updates, and additions and/or deletions of data relating to landlord, property, and/or unit. Agents can record notes, which may be saved for example in chronological order. Furthermore, each field of a category may create notes when updated. Automatic note creation may be provided, advantageously creating a record to resolve accidental changes or deletions for future reference. Users modifying a field or record may have their credentials associated with the change. The change may also be date and/or time stamped.

Statistical reports may be generated by authorized users to determine the volume of work performed in a reported period by a user. This transparency and accountability may optimally create a team culture focused on and paid for performance.

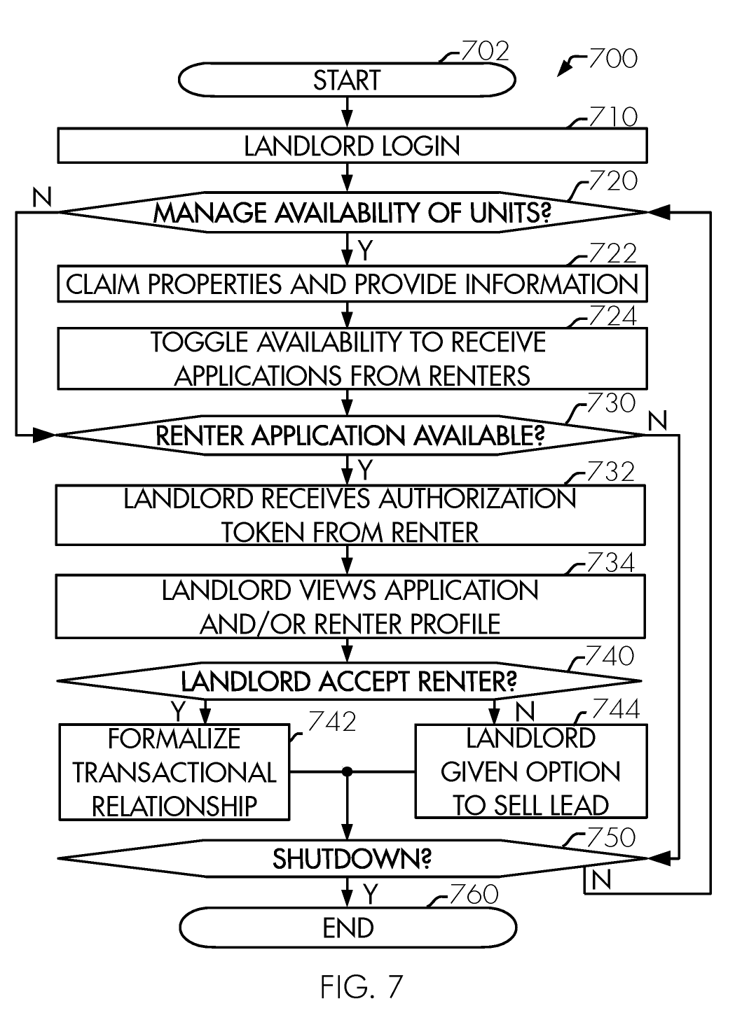

The landlord direct component will now be discussed in greater detail. FIGS. 1 and 7 highlight examples of the landlord direct component, which may also be shown in other figures. The landlord direct component 140 may share some features with the broker-assisted component 130 and other components, which are discussed in greater detail above. In some embodiments, a broker-assisted landlord component may be provided, which may include some of the structure and features of the landlord direct component and broker-assisted component provided throughout this disclosure.

The landlord direct component 140 may provide an interactive renter/landlord/vendor platform to manage the entire transaction process via a network connected interface. The landlord direct component may enable renter applicants and landlords to complete substantially the entire rental process online, starting by searching and applying to any of a voluminous number of active listings and upcoming rental opportunities on the site. Renters can then catalog and rate their unit viewings, communication experience, negotiation, and sign a lease via the platform. Once renters sign a lease, they may begin a transactional relationship with the landlord as a tenant. As tenants, they may join the tenant community to pay rent online, make maintenance requests, chat with their friends, and earn discounts on local deals. Features of the tenant community may be provided by the tenant management component 142.

Renter and tenant activities, renter/tenant profiles, renter scores, ratings, risk scores, and reviews may contribute to the data used by the payment and financial platforms discussed above. From the available portals and interface aspects, landlords and vendors may easily manage the income/expenses, communication and maintenance requests, reporting, accounting, bookkeeping, tax accounting/reporting, invoicing/collections/disputes, marketing, constant contact, newsletters, promotions, ratings, reviews, and more from their portal.

The renter search aspect will now be discussed. Using the landlord direct component 140, landlords may search for prospective renters. In the traditional process, renters contact landlords. The renter search aspect enables landlords to directly, manually, or substantially automatically search for and contact renters who match the landlord requirement for a unit. The renter score and tenant score may be connected, but are not required to be interchangeable. For example, a prospective renter may be a tenant with another landlord and considered a renter until they become a tenant with the listing landlord. The tenant score and renter score may be related, but may not be interchangeable in this example. Skilled artisans will appreciate additional aspects of the renter score and/or tenant score, which may be realized in alternative embodiments, after having the benefit of this disclosure.

To apply for a landlord's unit through the landlord direct component 140, rather than passively wait for renters to contact them, landlords may invite member or new renters to go through the analysis and matching processes described throughout this disclosure, allowing landlords to save time and interview/consider only qualified renters.

The record keeping aspect will now be discussed. Records may be created through interaction by the parties with the landlord direct component 140. Additionally, records may be created during interacting by the parties with one or more of the additional platform components 110. Records may relate to renter profiles, unit listing details, communications, concessions, rental payment history if any, employment history, saving history, ratings, reviews, compatibility score, and other information that may be pertinent to the entering of a transactional relationship between the parties. For renters that have become tenants, records may continue to be maintained relating to the tenancy, for example, rent payment amounts and dates, maintenance requests, reviews, ratings, neighbor complaints, and other information that may be pertinent to a transactional relationship between the parties. The landlord management component 142 may additionally communicate with the record keeping aspect to create and maintain records relating to the transactional relationship.

The renter/tenant community aspect will now be discussed. The renter/tenant may join a renter/tenant community. Renters may join an online renter community which may be separate from a tenant community. On a renter community, renters pay application fees, submit information for matching to a real property unit, maintain landlord's listing data in substantially real-time and have access to other information and perform other functions. After the renter signs a lease, entering a transactional relationship with a landlord as a tenant, the tenant may join a tenant community. Some community features may be shared between the renter community and tenant community, such as the features listed above. For the purposes of the renter community aspect, tenant community features may be included. Additionally, tenants may submit maintenance requests, rate landlords, neighbor-tenants, vendors, local businesses, and earn rewards and discounts for being a good tenant and neighbor. Information may be aggregated during the renter and/or tenant community experience, at least part of which may be used to create a renter score and anticipate landlord/tenant success probability by understanding tenant/landlord and tenant/tenant compatibility. The insight provided by the renter score may leverage behavioral analytics to reduce the likelihood of lease default resulting from factors leading to behavioral incompatibility.

The renter community aspect may promote documentation and transparency. To avoid potential argument, confusion, and lack of transparency, a landlord and renter can interact on the renter community, may have recorded communication, aspect and other aspects of the platform before, during, and after they sign the lease. This documentation and transparency feature additionally promotes continuity of communication and transparency for future reference.

The renter community may provide a social media aspect of the tenant/renter community connecting renters via a tenant/renter only social network. The tenant/renter community may additionally provide truth in reviews and ratings. The tenant/renter community may provide verified rating and review data. For example, ratings for a real property unit or service to that real property unit may be restricted to only tenants who've signed a lease for that unit. The tenant/renter community may also include a commerce aspect where tenants/renters, vendors, third parties, and/or landlords may purchase and engage in commerce. The commerce aspect may include a renter community marketplace where goods and services may be transacted from renters/tenants-to-renters/tenants, landlords-to-renters/tenants, landlords-to-landlords, and between renters, tenants, landlords, and/or third-party merchants. Commerce may include but is not limited to donations, investments, trade, sale/purchase, consign, loan, crowdfunding, buyer groups, and more.

The landlord direct component may additionally share aspects and features with the broker-assisted component. In some embodiments, the landlord direct component may operate at least partially with the broker-assisted components and other components to assist parties in establishing a transactional relationship, and may have data sharing incumbrances.

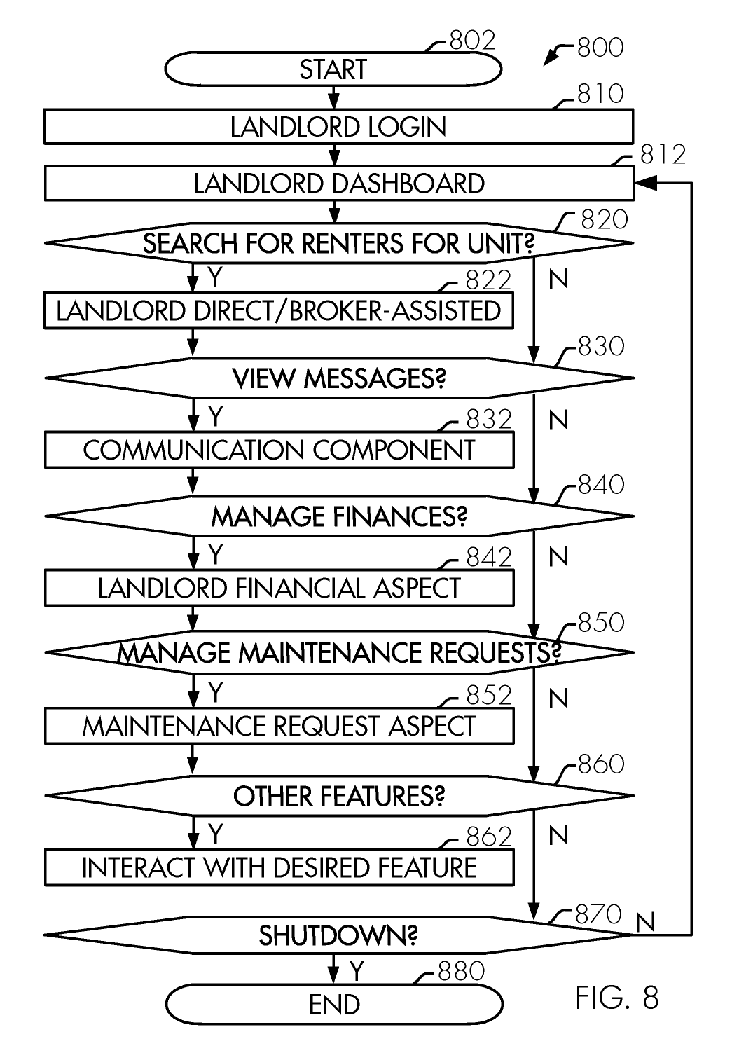

The landlord management component will now be discussed in greater detail. FIGS. 1 and 8 highlight examples of the landlord management component, which may also be shown in other figures. In some embodiments, the landlord direct component may include at least part of the landlord management component, without limitation.

The landlord financial aspect of the landlord management component 142 will now be discussed. Once renters sign a lease, they may begin a transactional relationship with the landlord as a tenant. As tenants, the former renter may join the tenant community to pay rent online, make maintenance requests, chat with their friends, create review and ratings, and earn discounts on local deals.

The landlord financial aspect may provide rental payment reporting services. Tenants and landlords may use the renter/tenant score for many benefits mentioned elsewhere in this disclosure. Rental payments may optionally be reported as verified rent payments to Experian, Equifax, and Transunion (tri-merge) credit reporting services. This reporting may advantageously update rental history for renters and landlords and this reporting may be done for a fee. Renter/tenant score may be used and may eventually be recognized as an alternative to the FICO score.

The landlord financial aspect may additionally provide accounting features for landlords. For example, landlords can collect rent online and manage their income and expenses. Landlords may analyze and generate reports for profitability by property, entity, by real property building, and by real property rental unit. Any repairs completed may be billed to either the renter and/or landlord. Vendor may be paid against rent proceeds, credit card, or some other payment method. Rent payments may be monetized. Landlords may also collect rent, pay bills, and perform other financial tasks from the landlord management component. In some embodiments, a convenience fee may be charged by the platform for online rent payment transactions. Billing made to the landlord may be substantially automatically recorded to the unit cost and offset income generated by the unit, building, company for year-end tax filing purposes. Tax filing and accounting services may be provided as a product of the platform and/or third-party service.

The maintenance request aspect of the landlord management component 142 will now be discussed. The maintenance request aspect may receive and manage maintenance requests relating to a real property unit. Data from the maintenance request may be shared with landlords, vendors, and agents upon request or authorization to share. The quick transmission of request data may advantageously reduce time to maintenance completion, invoicing, and cost payments while increasing profitability and tenant satisfaction. Vendor/landlord transaction may be partially or substantially automated by establishing an escrow amount funded by the landlord, rent, security deposit, renter/tenant, or line of credit and against which payment to vendor may be made on mutual agreement of satisfaction of a work order.

Tenants may make a maintenance request from their smartphone, for example, by taking a photo/video of the issue, categorizing the photo by the maintenance type, selecting priority level, writing the description of the issue, and/or sending the request to the landlord and/or an authorized person. Renters can reject request, schedule maintenance appointments, review status, invoice, pay, and dispute/arbitrate through the landlord management component. Dispute and arbitration for renters is a huge time and money saver for landlords and may reduce likelihood of eviction and/or the hiring of attorneys by each party to resolve matters. Often, renters are confused about their rights and obligations, and take actions, such as withholding rent to their detriment. This may be frowned upon in their legal cases and may lead to a judgment for the landlord because of the renter being unaware of how to properly solve a dispute. Arbitration may help the renter and landlord avoid situations that lead both to solve their differences in court. Negative review ratings can cause a system trigger to offer arbitration services to the dissatisfied party, which may encourage cooperation, reduce GRIP claims, and improve user ratings and overall user experience.

For the landlord, once the maintenance request is received by the landlord and/or maintenance person, the maintenance type and urgency level can be recategorized by the landlord. A category selected by the tenant may instantly show appropriate vendors based on the category and urgency. Maintenance requests may be quickly reviewed and assigned to a contractor/maintenance person based on the maintenance type and priority level which can be confirmed or changed by the landlord. Priority level may further refine the vendor list by vendor availability. Most urgent matters may produce vendor results to those who are most immediately available, and less urgent matters can be offered to vendors whose calendars are more open at later days of the week/month. A bidding aspect may be available for contractors to bid on posted jobs. This process may alleviate phone intake and scheduling for landlords and vendors. Landlords can interview, schedule, review, invoice, pay, dispute/arbitrate, and more, through the management component in the landlord's portal.

Aspects relating to vendors, vendor management, and interaction by the vendors via an interface, for example a vendor dashboard, will now be discussed without limitation. From the available portals and interface aspects, vendors may easily manage the income/expenses, communication and maintenance requests, reporting, accounting, bookkeeping, tax accounting/reporting, invoicing/collections/disputes, marketing, constant contact, newsletters, promotions, ratings, reviews, and more from their portal. Vendors may set their availability, which may assist in determining eligibility for maintenance requests with high urgency. Vendors may manage relationships with multiple landlords, tenants, agents, brokers, and other associations. Vendors may rate landlords, tenants, renters, agents, brokers, and other vendors. Likewise, landlords, tenants, renters, agents, brokers, and other vendors may rate a vendor. Additional discussions about vendors, vendor interaction with the system, and interaction by other parties with vendors is provided throughout this disclosure.

For the vendor, the landlord may easily select one or more vendors through the landlord management component. Vendors may be provided an option to accept or reject the maintenance performance invitation. Vendors can schedule, review, invoice, get paid, and dispute/arbitrate through the landlord management component.

The landlord-vendor management aspect will now be discussed. Vendors can subscribe to be on a vendor list to be hired by renters, landlords and/or authorized persons. Landlords and/or property managers can assign vendors to answer routine or emergency maintenance requests, which can be initiated by renters, landlords, and/or authorized persons

Landlords and/or authorized persons may easily review and respond to maintenance requests simply with the press of a button or the swipe on a touch screen. While renters, landlords, and vendors interact, these participants may be rated on experiences that may affect respective member scores. Vendor services may also include escrow protection, which may advantageously reduce litigation, encourage cooperation, and increase efficiency and transparency. Vendors may use similar accounting features to manage their income and expenses as other parties.

The lead marketplace component will now be discussed in greater detail. FIGS. 1 and 3-16 highlight examples of the lead marketplace component, which may also be shown in other figures. The lead marketplace component may be operated to selectively transact the renter profile among agents and optionally landlords. The lead marketplace component may include a lead pool aspect, which may provide a marketplace for agents and landlords to buy leads from and sell leads to other agents, brokerages, teams, landlords, and/or authorized buyer. A renter lead marketplace may be provided for agent only, landlord only, or both agent and landlord. For agent/managing broker/brokerage/team, the renter lead access may be designated to a hierarchy level, and/or designated functional group, team, staff, freelancer, employee, for the purpose to also manage, transfer, buy, sell, trade, and assign originated, worked, and/or purchased leads.

The lead marketplace component may facilitate lead tracking. Transferred, sold, and assign leads may be sold for a fixed or otherwise definable amount with an agreement. Alternatively, a fixed or definable amount plus a percentage of gross commission income (GCI) may be used to benefit the originating agent. Tracking tools may be provided to inform the originating agent whether the renter signed a lease by giving limited visibility to the renter's case log. The limited access may show system registered activity including, but not limited to, system logs, last completed category, electronic communication, electronic transactions, uploads, documents, images, forms, activity logs, downloads, leases, notes, annotations, arbitration logs, and/or other designated information.

Rules may be established for selling and assigning leads. For example, an agent may be restricted from assigning leads that were assigned to the agent. However, the agent may be unrestricted from transacting the leads that agent purchased or originated. In another example, an agent may reject purchased and assigned leads. Rejecting and/or rating leads may establish lead quality. Rating purchased leads may contribute to the seller's rating and seller history. Rejections, ratings, and reviews may be used by the agent community. Once purchased, leads may be assigned to be serviced by staff and/or other agents in an agent's team hierarchy. Rules may be updatable and subject to change.

The lead marketplace component may include a renter lead marketplace for landlords. Landlords may collect dozens of renter applications for each rental listing while a unit is on the market. After a renter is selected for the rental property, the landlord will generally have other renter applicants who were not selected. Using the renter leads marketplace, the landlord can convert those extra applications into leads. Landlords may sell leads to other landlords, agents, teams, brokerages, or other authorized buyers. The landlord may be required to provide proper disclosures to the renter during the application data gathering process, giving renter applicant notice that landlord may sell, trade, transfer renter data in the renter leads marketplace. Marketable leads may include renter information from the renter profile sufficient to decide who to allow to rent an available or upcoming real property unit.

Originated or purchased leads can be “worked” or built up to be more complete and closer to the lease signing stage. Once worked, the lead can be resold, potentially fetching a higher market value based on how much work was completed on that renter case to bring it closer to close. For example, provided without limitation, a renter lead that just started the process may only be worth $40, however after the agent, broker, or team helps the renter with document uploading and building the renter's profile, the lead may now be worth $160. The more marketable “worked” lead may now be sold to another agent who would only work on a lead with a substantially complete renter profile.

The guaranteed rental income protection will now be discussed in greater detail. FIGS. 1 and 3-6 highlight examples of the guaranteed rental income protection, which may also be shown in other figures. Guaranteed rental income protection (GRIP) 116 may use actuarial science and weighing to determine risk associated with a renter. A renter with a sufficiently acceptable GRIP rating, which meets a threshold of eligibility for GRIP, may be eligible for assurances that tenant will pay rent in a timely manner. GRIP 116 may consider combined risk, landlord score, and/or renter score, tenant score, ratings, reviews, and other factors for an income property. The platform may determine whether to offer GRIP for eligible renters, tenants, and/or landlords and for what cost and coverage amounts, if any.

The GRIP plan may protect the landlord's rental income against lease default, covering eviction costs and advantageously some or all unpaid rent which results from renter lease default. GRIP coverage terms and conditions may be based on which packages the renter/tenant and/or landlord agree to purchase, their individual scores, and/or their combined scores. With GRIP, landlords can make decision to accept a renter quickly and with confidence.

GRIP may be affiliated with lending products. Once a landlord's renter occupancy percentage in a building achieves a certain GRIP subscription saturation, the platform may be able to leverage this income security to help the landlord obtain better financing terms on their mortgage or another line of credit. A lending platform and/or syndicated lending products may offer landlords access to more financing options with better terms, so landlords can finance, refinance, obtain credit cards and other financial instruments at lower rates and/or repayment options. The lending platform may advantageously provide commercial lending options in as large a variety and flexibility as those offered to residential home buyers.

GRIP plans may include a purchase option. A GRIP pre-approval letter may be conditional on its issuance to approved landlords. A standalone GRIP letter can be issued with restrictions if an approved landlord is not linked to the GRIP approved renter/tenant. Renter applicants may choose a GRIP approved landlord and/or suggest a landlord to be reviewed for GRIP approval. GRIP plans may come with a coverage period, coverage amount, upfront, ongoing, and/or per event cost(s), inclusions, exclusions, claim instructions, and/or general instructions. Tenant and/or landlord may also apply to purchase a GRIP plan during an active lease period.

In the event of lease default, a loss may be claimed against GRIP, which may be reviewed to determine claim eligibility. Claim eligibility may consider landlord's commitment to specific guidelines under terms of service, terms of lease, tenant's rights, quality of maintenance and condition of real property unit and real property building. Claim eligibility may consider renter's commitment to honor lease and tenancy terms, if any. Claim disbursements may cover at least some of the unpaid rent, cost for special or regular process server, court filing, and/or attorney's fees in varying coverage portions based on eligibility and GRIP terms of service. Mediation may be offered or required to resolve disputes without legal action. If resolution is not reached, legal action may be necessary. An agreed cost of legal action may be covered by GRIP. Additionally, finding a replacement tenant to mitigate company's and/or landlord's income loss may also be included in GRIP. Repairs to damage caused by a renter may be a necessary element to bring a real property unit to rentable condition may be partially or entirely covered by GRIP. Deductible, security deposit, collected premiums, garnishment and judgements against the defendant, if any, may be used to offset GRIP costs. Some of these features and more may be included in a customizable GRIP package.

GRIP lending products may be provided. Real estate investment trust (REIT) companies may also benefit from using income protection to create added security for the investors who invest in REIT asset portfolios. Income protected investments may provide a competitive advantage to REITs who are the first to use GRIP protected assets. GRIP may be provided as a financial product including for factoring receivables and using other liability mitigation techniques. GRIP may be factored, selling this receivable/liability at a discount for immediate cash infusion to offset future liability. GRIP may also be bundled and sold as a bond or some other short-term security to manage risk, asset-to-liability ratios, and hedge against economic or political risk. Experience charts may be used to establish guaranteed rental income protection (GRIP) values to protect some or all the landlord's rental income, for a determinable duration and plan cost. Experience charts may be used to determine lease default probability. GRIP may be offered to only qualified tenants with financial stability, those who operate within defined rules, and/or meet defined thresholds for eligibility. GRIP may be offered in the form of a card, certificate, policy, and/or other instrument. GRIP may be a financial instrument that can be bought, sold, transferred, traded, collateralized, leveraged, factored, packaged and/or derivatized.

The renter profile validation aspect will now be discussed in greater detail. FIGS. 1 and 3-6 highlight examples of the renter profile validation aspect, which may also be shown in other figures. The renter component may further include a renter profile validation aspect to receive documentation that is intended to validate at least part of the renter information included by the renter profile. The renter profile validation aspect may communicatively cooperate with the matching component, broker-assisted component, and/or landlord direct component to compare renter-supplied information with the information included in evidence including uploaded documents, indirectly-sourced data, and third-party data sources. The renter information determined not to be valid may be selectively purged from the renter profile. The renter/tenant score may be adjusted for false information about the renter/tenant.

The tenant exchange will now be discussed in greater detail. FIG. 1 highlights examples of the tenant exchange, which may also be shown in other figures. The tenant exchange 118 may provide a marketplace to transact rights to rental income from tenants. The tenant exchange 118 may include a renter's auction, which may allow renter scores and landlord scores to be considered to match renters and landlords together based on their scores. Score rated members may have the option to “opt in” and participate in being instantly matched via the tenant exchange 118, by an initiating party, system, electronic registry, renter/tenant, or landlord. Like the stock exchange, renters/tenants and landlord may bid or engage in a transactional relationship using “virtual calls and puts” via the online tenant exchange 118. This novel exchange advantageously provides a significant competitive advantage to renters living in cities where renting is highly competitive. Renters can bid against each other to rent from a landlord, tenant, or lease holder; and lease holders/landlords may bid against each other to attract a tenant. Similarly, renter groups can bid to purchase real property and landlord groups can bid to purchase real property. Tenant/renter groups and landlord groups can bid against each other or work together to purchase real property or otherwise engage in crowdfunding.

Referring now to FIG. 2, an illustrative computerized device will be discussed, without limitation. Various aspects and functions described in accord with the present disclosure may be implemented as hardware or software on one or more illustrative computerized devices 200 or other computerized devices. There are many examples of illustrative computerized devices 200 currently in use that may be suitable for implementing various aspects of the present disclosure. Some examples include, among others, network appliances, personal computers, workstations, mainframes, networked clients, servers, media servers, application servers, database servers and web servers. Other examples of illustrative computerized devices 200 may include mobile computing devices, cellular phones, smartphones, tablets, video game devices, personal digital assistants, network equipment, devices involved in commerce such as point of sale equipment and systems, such as handheld scanners, magnetic stripe readers, barcode scanners and their associated illustrative computerized device 200, among others. Additionally, aspects in accord with the present disclosure may be located on a single illustrative computerized device 200 or may be distributed among one or more illustrative computerized devices 200 connected to one or more communication networks.

For example, various aspects and functions may be distributed among one or more illustrative computerized devices 200 configured to provide a service to one or more client computers, or to perform an overall task as part of a distributed system. Additionally, aspects may be performed on a client-server or multi-tier system that includes components distributed among one or more server systems that perform various functions. Thus, the disclosure is not limited to executing on any system or group of systems. Further, aspects may be implemented in software, hardware or firmware, or any combination thereof. Thus, aspects in accord with the present disclosure may be implemented within methods, acts, systems, system elements and components using a variety of hardware and software configurations, and the disclosure is not limited to any distributed architecture, network, or communication protocol.

FIG. 2 shows a block diagram of an illustrative computerized device 200, in which various aspects and functions in accord with the present disclosure may be practiced. The illustrative computerized device 200 may include one or more illustrative computerized devices 200. The illustrative computerized devices 200 included by the illustrative computerized device may be interconnected by, and may exchange data through, a communication network 208. Data may be communicated via the illustrative computerized device using a wireless and/or wired network connection.

Network 208 may include any communication network through which illustrative computerized devices 200 may exchange data. To exchange data via network 208, systems and/or components of the illustrative computerized device 200 and the network 208 may use various methods, protocols and standards including, among others, Ethernet, Wi-Fi, Bluetooth, TCP/IP, UDP, HTTP, FTP, SNMP, SMS, MMS, SS7, JSON, XML, REST, SOAP, RMI, DCOM, and/or Web Services, without limitation. To ensure data transfer is secure, the systems and/or modules of the illustrative computerized device 200 may transmit data via the network 208 using a variety of security measures including TSL, SSL, SFTP, SSH, or VPN, among other security techniques, for example, through a web application firewall to protect user data against virus and malware. The illustrative computerized device 200 may include any number of illustrative computerized devices 200 and/or components, which may be networked using virtually any medium and communication protocol or combination of protocols.

Various aspects and functions in accord with the present disclosure may be implemented as specialized hardware or software executing in one or more illustrative computerized devices 200, including an illustrative computerized device 200 shown in FIG. 2. As depicted, the illustrative computerized device 200 may include a processor 210, memory 212, a bus 214 or other internal communication system, an input/output (I/O) interface 216, a storage system 218, and/or a network communication device 220.

Additional devices 222 may be selectively connected to the computerized device via the bus 214. Processor 210, which may include one or more microprocessors or other types of controllers, can perform a series of instructions that result in manipulated data. Processor 210 may be a commercially available processor such as an ARM, x86, Intel Core, Intel Pentium, Motorola PowerPC, SGI MIPS, Sun UltraSPARC, or Hewlett-Packard PA-RISC processor, but may be any type of processor or controller as many other processors and controllers are available. As shown, processor 210 may be connected to other system elements, including a memory 212, by bus 214.

The illustrative computerized device 200 may also include a network communication device 220. The network communication device 220 may receive data from other components of the computerized device to be communicated with servers 232, databases 234, smart phones 236, and/or other computerized devices 238 via a network 208. The communication of data may optionally be performed wirelessly. More specifically, without limitation, the network communication device 220 may communicate and relay information from one or more components of the illustrative computerized device 200, or other devices and/or components connected to the computerized device 200, to additional connected devices 232, 234, 236, and/or 238. Connected devices are intended to include, without limitation, data servers, additional computerized devices, mobile computing devices, smart phones, tablet computers, and other electronic devices that may communicate digitally with another device. In one example, the illustrative computerized device 200 may be used as a server to analyze and communicate data between connected devices.

The illustrative computerized device 200 may communicate with one or more connected devices via a communications network 208. The computerized device 200 may communicate over the network 208 by using its network communication device 220. More specifically, the network communication device 220 of the computerized device 200 may communicate with the network communication devices or network controllers of the connected devices. The network 208 may be, for example, the internet. As another example, the network 208 may be a WLAN. However, skilled artisans will appreciate additional networks to be included within the scope of this disclosure, such as intranets, local area networks, wide area networks, peer-to-peer networks, and various other network formats. Additionally, the illustrative computerized device 200 and/or connected devices 232, 234, 236, and/or 238 may communicate over the network 208 via a wired, wireless, or other connection, without limitation.

Memory 212 may be used for storing programs and/or data during operation of the illustrative computerized device 200. Thus, memory 212 may be a relatively high performance, volatile, random access memory such as a dynamic random access memory (DRAM) or static memory (SRAM). However, memory 212 may include any device for storing data, such as a disk drive or other non-volatile storage device. Various embodiments in accord with the present disclosure can organize memory 212 into particularized and, in some cases, unique structures to perform the aspects and functions of this disclosure.

Components of illustrative computerized device 200 may be coupled by an interconnection element such as bus 214. Bus 214 may include one or more physical busses (for example, busses between components that are integrated within a same machine), but may include any communication coupling between system elements including specialized or standard computing bus technologies such as USB, Thunderbolt, SATA, FireWire, IDE, SCSI, PCI and InfiniBand. Thus, bus 214 may enable communications (for example, data and instructions) to be exchanged between system components of the illustrative computerized device 200.

The illustrative computerized device 200 also may include one or more interface devices 216 such as input devices, output devices and combination input/output devices. Interface devices 216 may receive input or provide output. More particularly, output devices may render information for external presentation. Input devices may accept information from external sources. Examples of interface devices include, among others, keyboards, barcode scanners, mouse devices, trackballs, magnetic strip readers, microphones, touch screens, printing devices, display screens, speakers, network interface cards, etc. The interface devices 216 allow the illustrative computerized device 200 to exchange information and communicate with external entities, such as users and other systems.

Storage system 218 may include a computer readable and writeable nonvolatile storage medium in which instructions can be stored that define a program to be executed by the processor. Storage system 218 also may include information that is recorded, on or in, the medium, and this information may be processed by the program. More specifically, the information may be stored in one or more data structures specifically configured to conserve storage space or increase data exchange performance. The instructions may be persistently stored as encoded bits or signals, and the instructions may cause a processor to perform any of the functions described by the encoded bits or signals. The medium may, for example, be optical disk, magnetic disk or flash memory, among others. In operation, processor 210 or some other controller may cause data to be read from the nonvolatile recording medium into another memory, such as the memory 212, that allows for faster access to the information by the processor than does the storage medium included in the storage system 218. The memory may be located in storage system 218 or in memory 212. Processor 210 may manipulate the data within memory 212, and then copy the data to the medium associated with the storage system 218 after processing is completed. A variety of components may manage data movement between the medium and integrated circuit memory element and does not limit the disclosure. Further, the disclosure is not limited to a particular memory system or storage system.

Although the above described illustrative computerized device is shown by way of example as one type of illustrative computerized device upon which various aspects and functions in accord with the present disclosure may be practiced, aspects of the disclosure are not limited to being implemented on the illustrative computerized device 200 as shown in FIG. 2. Various aspects and functions in accord with the present disclosure may be practiced on one or more computers having additional components than that shown in FIG. 2. For instance, the illustrative computerized device 200 may include specially-programmed, special-purpose hardware, such as for example, an application-specific integrated circuit (ASIC) tailored to perform a particular operation disclosed in this example. While another embodiment may perform essentially the same function using several general-purpose computing devices running Windows, Linux, Unix, Android, iOS, MAC OS X, or other operating systems on the aforementioned processors and/or specialized computing devices running proprietary hardware and operating systems.

The illustrative computerized device 200 may include an operating system that manages at least a portion of the hardware elements included in illustrative computerized device 200. A processor or controller, such as processor 210, may execute an operating system which may be, among others, an operating system, one of the above mentioned operating systems, one of many Linux-based operating system distributions, a UNIX operating system, or another operating system that would be apparent to skilled artisans. Many other operating systems may be used, and embodiments are not limited to any particular operating system.

The processor and operating system may work together define a computing platform for which application programs in high-level programming languages may be written. These component applications may be executable, intermediate (for example, C# or JAVA bytecode) or interpreted code which communicate over a communication network (for example, the Internet) using a communication protocol (for example, TCP/IP). Similarly, aspects in accord with the present disclosure may be implemented using an object-oriented programming language, such as JAVA, C, C++, C#, Python, PHP and PHP-based platforms like CakePHP or Codeigniter, other platforms such as Laravel, AugularJS variants, Node.JS, Visual Basic .NET, JavaScript, Perl, Ruby, Delphi/Object Pascal, Visual Basic, Objective-C, Swift, MATLAB, PL/SQL, OpenEdge ABL, R, Fortran or other languages that would be apparent to skilled artisans. Other object-oriented programming languages may also be used. Alternatively, assembly, procedural, scripting, or logical programming languages may be used.

Additionally, various aspects and functions in accord with the present disclosure may be implemented in a non-programmed environment (for example, documents created in HTML5, HTML, XML, CSS, JavaScript, or other format that, when viewed in a window of a browser program, render aspects of a graphical-user interface or perform other functions). Additionally, various aspects of this disclosure may be developed for mobile devices, implemented in Bootstrap HTML/HTML5, iOS, C, C++, NDK, C#, as well as cross platform languages such as PhoneGap or Ionic. Ajax may be one of the techniques used on the client side interface to create asynchronous web applications. Further, various embodiments in accord with the present disclosure may be implemented as programmed or non-programmed elements, or any combination thereof. For example, a web page may be implemented using HTML while a data object called from within the web page may be written in C++. Thus, the disclosure is not limited to a specific programming language and any suitable programming language could also be used.

An illustrative computerized device included within an embodiment may perform functions outside the scope of the disclosure. For instance, aspects of the system may be implemented using an existing commercial product, such as, for example, Database Management Systems such as a SQL Server available from Microsoft of Redmond, Wash., Oracle Database or MySQL from Oracle of Redwood City, Calif., or integration software such as phpMyAdmin, WebSphere middleware from IBM of Armonk, N.Y.

In operation, a method may be provided to facilitating matching, engaging, contracting, and communicating between parties to a real estate and/or property rental transaction by a network-leveraged system. Those of skill in the art will appreciate that the following methods are provided to illustrate an embodiment of the disclosure, and should not be viewed as limiting the disclosure to only those methods or aspects. Skilled artisans will appreciate additional methods within the scope and spirit of the disclosure for performing the operations provided by the examples below after having the benefit of this disclosure. Such additional methods are intended to be included by this disclosure.

Illustrative agent/broker operations will now be discussed, without limitation. Agents, brokers, and other transaction facilitators may interact with the platform according to their role. A user can sign up as an advertiser, landlord aggregator, agent, or managing broker or office and then develop their role to transition into another role. Roles may be changed and/or expanded. Other support roles may also be provided, as will be appreciated by those of skill in the art after having the benefit of this disclosure.

Once the agent, managing broker, brokerage office is registered they can manage their dashboard and perform tasks such as managing and transacting leads, managing renter applicants, calendar appointments, property listings, property map, CMS and all of the features involved in the CMS including newsletter creating and cron scheduling and various agent created and system provided forms and templates, inbox messages, searching/managing the landlord database, managing financials, stats, open agreements, team plans, reporting and their local and virtual teams. Managing renter applicants may include the review of a renter profile including renter risk, renters score, screening questionnaires, uploaded documents, electronic forms, long and short message communication, matching renters to available properties, financial/GRIP accounting, and document verification. Leads can be bought, sold, and managed through the lead pool system. Staff activity can be tracked and monitored using built in statistics charts and queries. Virtual teams can be associated to and disassociated from the other team hierarchies and the hierarchy diagram may be visible through the team dashboard.

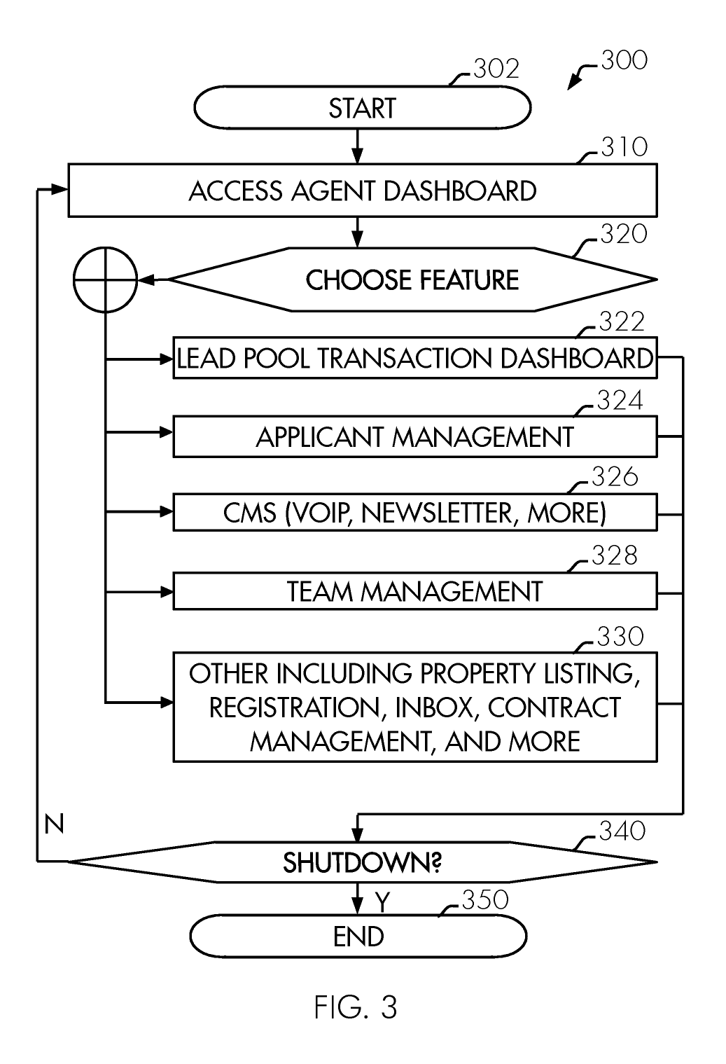

Referring now to flowchart 300 of FIG. 3, an illustrative method for an agent management operation will be described, without limitation. Starting with block 302, the operation may begin by an agent accessing their agent dashboard. (Block 310). If the agent does not yet have an agent profile, they may be offered to create one. Use of the term agent may include functions that are also available in the managing broker or brokerage dashboard.

The agent may then choose a desired feature. (Block 320). If the agent desires to manage and transact leads, the agent may access the lead pool transaction dashboard and also the payment account management dashboard so that agent may add/withdraw money. (Block 322). Here, the agent may view and manage apartment listings so advertising teams can post advertisements with photos and unit details, for example. If the agent desires to manage applicants and their respective applications, the agent may access the applicant management feature. (Block 324). Here, the agent may interact with risk/cost summaries, screening questionnaires, uploaded documents, forms, messages, matching properties, and accounting features.

If the agent desires to manage CMS to view and schedule a real property viewing, see business hours, access a record, or make calls, the agent may access the CMS feature set. (Block 326). The CMS feature set may include, but is not limited to, purchase number VOIP account connection to agent account, auto-responder content, cron settings for various follow-up tasks, first contact and other trigger event, or other fully/partially/substantially-automated features which are used to send in-app, email, phone, social media, blog and other communication for/to renter, tenant, landlord, local/virtual team, agent, broker, brokerage. If the agent desires to manage their team, the agent may access the team management feature. (Block 328). If the agent desires to find a new managing broker or brokerages, join new hierarchy or expand agent's hierarchy branch, the agent can access the Team feature. If the agent desires to engage another feature, such as a calendar, property listings, registration process, map, inbox, contract management, new landlord record creation, manage landlord data, manage renter/landlord hotlist, active list, pending action list, CMS, profile builder, or other feature, the agent may access that feature or any future that may be later added or expanded. (Block 330). The profile builder may include a tool to substantially automate the creation of a renter profile to assist agent with presenting the renter profile to a landlord. Inclusion of a profile builder tool may advantageously require less time and effort while providing increased accuracy in renter information associated with the renter profile, increasing the likelihood of a successful outcome for a renter/tenant who engaged agent for such services.

The agent may then determine whether to terminate their session at block 340. If it is determined at block 340 not to terminate the session, the agent may then be redirected to again access the agent dashboard at block 310 if the session is not automatically expired. If it is determined at block 340 to terminate the session, the operation may end at block 350 and notice of eminent session termination may be declared to agent.

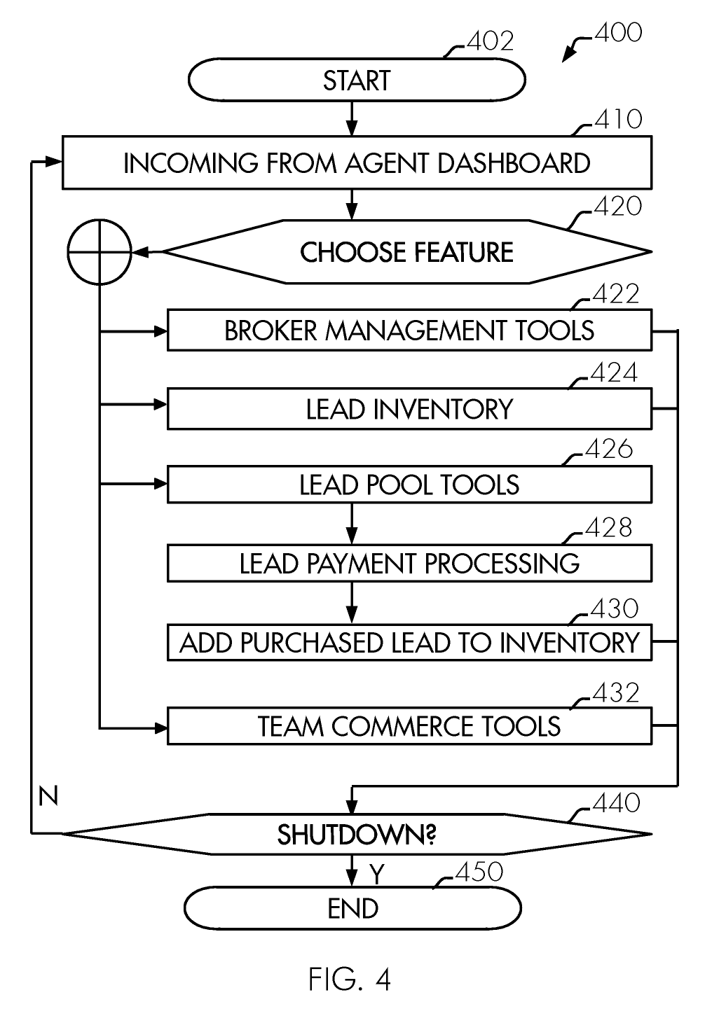

Referring now to flowchart 400 of FIG. 4, an illustrative method for a lead pool transaction aspect of the agent management operation will be described, without limitation. Starting with block 402, the operation may begin by the agent incoming from the agent dashboard. (Block 410). This step may include substantially all agent dashboard features.

The agent may then choose a desired feature. (Block 420). If it is determined at block 420 that the agent desires to interact with broker management tools, the agent may be directed to the broker management tools feature to monitor and manage agent activity, including adding and removing agents. (Block 422). The broker management tools of this step may include association/disassociation. If it is determined at block 420 that the agent desires to interact with the lead inventory, the agent may be directed the lead inventory features to view open, selling or sold leads. (Block 424). If it is determined at block 420 that the agent desires to interact with lead pool tools, the agent may be directed to the lead pool tools feature buy, sell, trade, and otherwise transact leads from the lead pool. (Block 426). In one example, lead pool trading may occur where many less expensive leads can be traded for fewer expensive leads.

From block 426, the agent may indicate a lead that they wish to purchase and proceed to payment processing. (Block 428). After the lead is purchased, the lead may be added to the agent's lead inventory. (Block 430). These added leads may then be assigned, sold, rejected, completed, or traded.

If it is determined at block 420 that the agent desires to engage with team commerce features, including the creation of local and/or virtual teams, the agent may be directed to the team commerce tools and features. (Block 432). Using the team commerce tools, the agent may define teams that can operate locally/virtually, establish a team hierarchy, manage broker/agent relations, manage team hierarchies, associate/disassociate team participants, and otherwise manage a team.

Incoming from blocks 422, 424, 430, or 432, the agent may then determine whether to terminate their session at block 440. If it is determined at block 440 not to terminate the session, the agent may then be redirected to incoming state from the agent dashboard at block 410. If it is determined at block 440 to terminate the session, the operation may end at block 450.

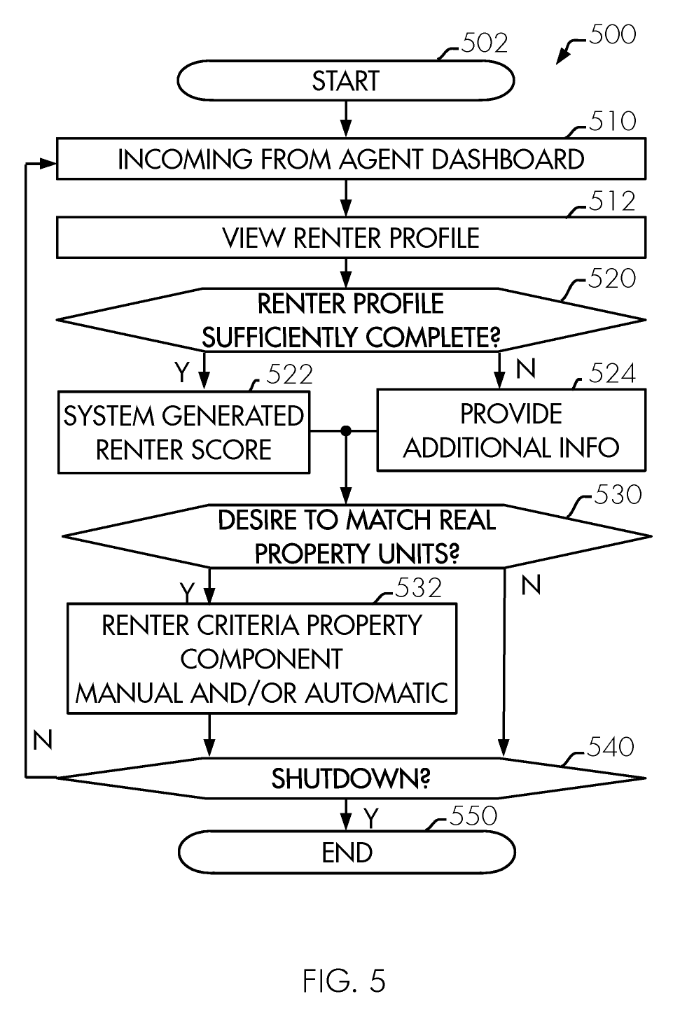

Referring now to flowchart 500 of FIG. 5, an illustrative method for an applicant management aspect of the agent management operation will be described, without limitation. Starting with block 502, the operation may begin by the agent incoming from the agent dashboard. (Block 510). The agent may then view a renter profile. (Block 512).

It may then be determined if the renter profile is sufficiently complete. (Block 520). If it is determined at block 520 that the renter profile is sufficiently complete, the operation may generate a renter score. (Block 522). If it is determined at block 520 that the renter profile is not sufficiently complete, the operation may request the additional information for the renter profile. (Block 524).

From the steps of blocks 522 or 524, the operation may determine whether it is desired to match real property units with a renter. (Block 530). If it is determined that it is desired to match real property units with a renter at block 530, the operation may search for real property units to match with the renter. (Block 532). Units suitable for matching may be included in a renter criterial property matching component, which may facilitate matching a landlord with an applicant by, for example, requiring a matching threshold indicating a likelihood of compatibility. Renter may also modify the search criteria to access search results which are different from those that may be produced from those generated by the auto-criteria search. In this example, a renter may include any user who is searching for new tenancy and may or may not be a tenant of another real property unit at the time of the search.

After the operation of block 532, or if it is determined at block 530 that it is not desired to match real property units, the agent determine whether to terminate their session at block 540. If it is determined at block 540 not to terminate the session, the agent may then be redirected to the incoming state from the agent dashboard at block 510. If it is determined at block 540 to terminate the session, the operation may end at block 550.

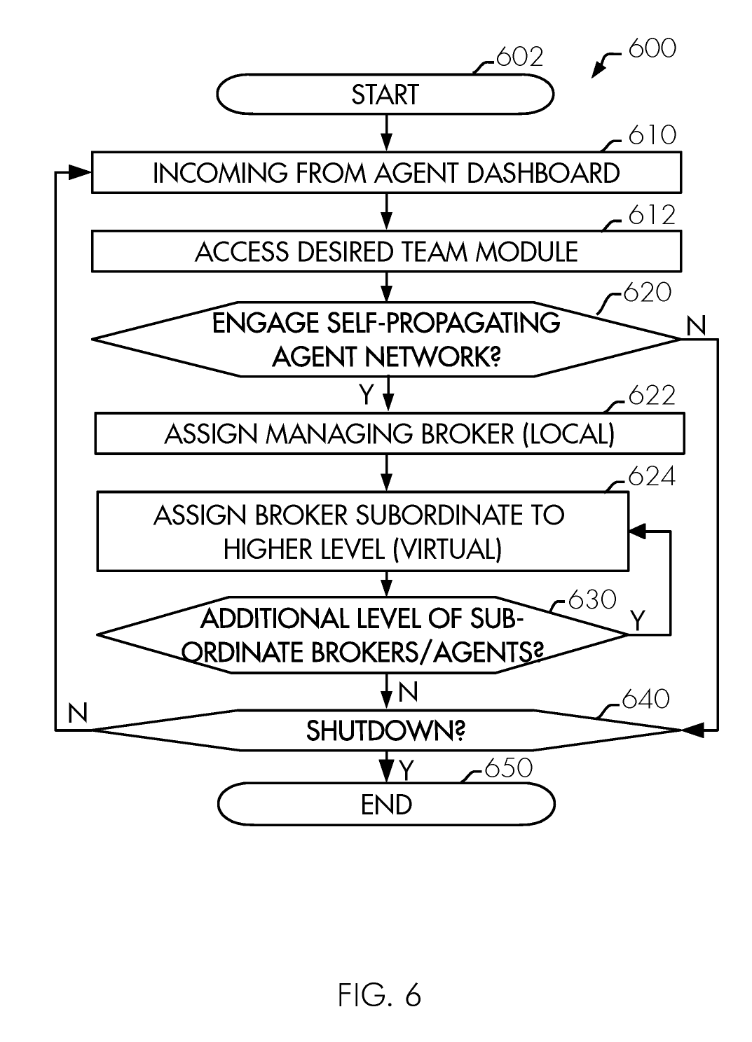

Referring now to flowchart 600 of FIG. 6, an illustrative method for a team management aspect of the agent management operation will be described, without limitation. Starting with block 602, the operation may begin by the agent incoming from the agent dashboard. (Block 610). The agent may then access the desired team module. (Block 612).

It may then be determined if the agent wishes to engage the self-propagating agent network. (Block 620). If it is determined at block 620 that the agent wishes to engage the self-propagating network, the operation may be initiated by the agent by requesting to join a team, or become a subordinate in that agent's hierarchy, or accepting request to become/expand agent's team. (Block 622). This may be performed locally. The operation may then assign brokers subordinate to the next higher level. (Block 624). This may be performed virtually. Subordinates may be arranged in a competitive and/or cooperative relationship.

It may then be determined whether an additional level of subordinate brokers is desired. (Block 630). If the relationship is virtual, the subordinates may be brokers/agents. If the relationship is local, the subordinates may include agents only. If it is determined at block 630 that an additional level of subordinate brokers is desired, the operation may return to block 624 and assign brokers subordinate to the last assigned level.

If it is determined at block 620 not to engage in a self-propagating agent network, or if it is determined at block 630 not to define an additional level of subordinate brokers, the operation may then determine whether to terminate the session at block 640. If it is determined at block 640 not to terminate the session, the agent may then be redirected to again access the desired team module at block 612. If it is determined at block 640 to terminate the session, the operation may end at block 650.

Illustrative landlord operations will now be discussed, without limitation. The landlord may have several options for onboarding. The landlord may be invited from a listing process, may visit the website, may be invited by an agent/broker/team/agency/renter/vendor to join. The landlord may be invited by a renter to view the renter's profile or in a broker-assisted process, the landlord may be invited by the renter's assisting agent to view the renter's profile. To view renter profiles, invites may be made with a temporary access token. If the landlord is not registered, the temporary token can give landlord time to view the profile and decide whether to move forward. The landlord may join from this point by registering from the landlord's temporary dashboard. Landlord may also register directly from the platform to claim an existing record or create new records. The landlord may also respond to a text message auto-reply which the landlord would receive by calling or texting an information number from an advertisement. The landlord may also scan a barcode or QR code on an advertisement or respond to a link which will direct landlord to sign-up. Vendors, agents, managing brokers, brokerages, and/or contractors may also be invited in the manner described above. The landlord may review rental applications that have come in or invite renter applicants. The landlord can also manage listings, create, edit, delete property and vacant units, answer maintenance request, and review renters. The renter may negotiate and sign a lease through the same portal. The landlord may hire teams to do maintenance, advertise, and delegate bookkeeping through the site.

Once logged in, the landlord may access a dashboard to invite and view renter profiles. The landlord may decide whether to rent to applicants. The landlord may also purchase, or require renters purchase, GRIP. The landlord may sell renter leads that the landlord did not accept for tenancy. If the landlord chooses to go through the landlord direct component, the landlord can sign up or login to manage properties and finances through built-in property management platform components. The landlord may invite a registered vendor or send an invite to a non-registered vendor, for example, directly from a landlord's dashboard with the purpose of hiring vendor to assist landlord or landlord can invite vendor with the incentive of getting compensated for any vendor who signs up and remains/performs in the system for some minimum threshold. At least some of these interactions may be tracked by the system.

Referring now to flowchart 700 of FIG. 7, an illustrative method fora landlord direct operation will be described, without limitation. Starting with block 702, the operation may begin by a landlord logging in (Block 710). If the landlord does not have login credentials, they may be given the opportunity to sign up.

It may then be determined if the landlord desires to manage availability of their units. (Block 720). If it is determined at block 720 that the landlord desired to manage the availability of their units, the landlord may claim properties and provide related information. (Block 722). The landlord may toggle rental unit availability to receive applications from renters for the available units. (Block 724).

From block 724, or if block 720 was decided in the negative, it may be determined if a rental application is available. (Block 730). If it is determined at block 730 that rental applications are available, the landlord may receive an authorization token from the renter to view the renter profile associated with the application. (Block 732). The landlord may then view the application and/or renter profile. (Block 734).

It may then be determined if the landlord will accept the renter. (Block 740). If it is determined at block 740 that the landlord will accept the renter, the parties may formalize the transactional relationship, for example, by signing a lease. (Block 742). Formalizing of the transactional relationship may also include negotiation of terms to be included by the transactional relationship, for example, in a lease. If it is determined at block 740 that the landlord will not accept the renter, the landlord may be given an opportunity to sell the lead to another landlord, agent, or entity. (Block 744).

From blocks 742 or 744, or if block 730 is decided in the negative, the landlord may then determine whether to terminate their session at block 750. If it is determined at block 750 not to terminate the session, the landlord may then be redirected to again determine whether to manage the availability of their units at block 720. If it is determined at block 750 to terminate the session, the operation may end at block 760.

Referring now to flowchart 800 of FIG. 8, an illustrative method for a landlord management operation will be described, without limitation. In some embodiments, the landlord may also have some of the same features as the agent, including CMS, team, and other features discussed along with FIG. 3 and throughout this disclosure. Starting with block 802, the operation may begin by the landlord logging in to the platform. (Block 810). If the landlord does not have login credentials, they may be given the opportunity to sign up. The landlord may then access the landlord dashboard. (Block 812).

It may then be determined whether to search for renters for an available unit. (Block 820). If block 820 is decided in the affirmative, the landlord may be sent to the landlord direct component or broker-assisted component. (Block 822). The selected component may depend on which is chosen, and a landlord may choose to use either or both components at any time, however, some restrictions may apply. Search may also be made by establishing search criteria which may include combined household income, total number of occupants, pets allowed, credit/star/risk/GRIP as desired, percentage of profile completion, and/or other criteria as permissible by law. Search criteria may reference profile data created by renters and/or the system.

From block 822, or if block 820 was decided in the negative, it may then be determined whether to view available messages. (Block 830). If block 830 is decided in the affirmative, the landlord may interact with the communication component to access an inbox and communicate with other parties. (Block 832).

From block 832, or if block 830 was decided in the negative, it may then be determined whether to manage finances. (Block 840). If block 840 is decided in the affirmative, the landlord may interact with the landlord financial aspect of the landlord management component. (Block 842). Here, the landlord may manage income, view rental income and expenses, and otherwise manage finances as discussed throughout this disclosure.

From block 842, or if block 840 was decided in the negative, it may then be determined whether to manage maintenance requests. (Block 850). If block 850 is decided in the affirmative, the landlord may be sent to the maintenance request aspect of the landlord management component. (Block 852). Here, the landlord may view requests from a maintenance inbox. The landlord may also view renter profiles associated with the requesting tenant and create rating and review.

From block 852, or if block 850 was decided in the negative, it may then be determined whether to access other features, such as reviewing of applications, management of listings, or other features. (Block 860). If block 860 is decided in the affirmative, the landlord may be sent to the aspect or feature related to the desired operation. (Block 862). Features and aspects of this disclosure that could be included for interaction at block 862 may include, but should not be limited to, a renter's marketplace, renter community social network, tenant community social network, management of a transactional relationship, reviews, ratings, communications, and other features that will be apparent to a person of skill in the art after having the benefit of this disclosure.

From block 862, or if block 860 was decided in the negative, the landlord may then determine whether to terminate their session at block 870. If it is determined at block 870 not to terminate the session, the agent may then be redirected to again access the landlord dashboard at block 812. If it is determined at block 870 to terminate the session, the operation may end at block 880.

Landlord may also manage staff, favorite vendors, direct hired agents, advertisers, and other support staff and third parties. Landlord can also access CMS and manage aspects of this section which may include purchased numbers, auto-responses, newsletters, and other features described for CMS elsewhere in this disclosure. Landlord may manage landlord's profile and available payment option to collect income and pay expenses.

Illustrative renter operations will now be discussed, without limitation. The renter may have several options to start the rental process, including broker assistance via the broker-assisted process and direct interaction with the landlord via the landlord direct process. For the broker-assisted process, that renter may start by accessing the platform, for example via a web-based interface, or starting from a landing page where the renter register using a form, for example, after being redirected from a call, text, link, barcode, QR code, or search engine. After renter registers and passes the initial criteria, the renter may schedule an appointment with an agent by scheduling time directly on an agent's calendar. This scheduling feature frees up time for the agent and reduces the dependency on a receptionist. If the renter chooses to schedule an appointment and does not show up, then the user will be substantially automatically given a reminder by the system to schedule another appointment to come in or re-engage with the process.

If the renter does come in, the renter may receive appointment reminders, and may also create the profile which includes completing screening information, uploading documents, completing forms and sending notifications, searching for properties and communicating with an agent and/or landlord directly through the customer's dashboard in their renter dashboard interface. Once a renter attends their appointment, or if the renter elects not to have an appointment, the renter can pay a processing fee to build a profile and start the service. At substantially any point, the renter can opt out to stop receiving communication

A landlord may substantially immediately have access to suggested listings based on the renter profile created for the renter. From these suggested listings, renter can customize the search and invite any landlord to view their renter profile. Upon receiving the invitation from the renter, the landlord can either register, create temporary access to view the renter's profile, or can log into the landlord's existing account.

From the landlord dashboard, the landlord can view invitations and applications for the rental units that are available now, or coming available in the future. If the landlord and renter wish to negotiate and proceed with a lease, the parties can do so substantially instantly through the lease form available to them online. Prior to lease, the renter and landlord may have the option of supplying their viewing experience/rating/reviews, and negotiating lease terms virtually. Throughout the entire process, an agent may be available to help the transaction.

If the landlord would like additional security as a condition of signing a lease, of if the renter wants to have an advantage over rival renter applicants, then the renter has the option of purchasing a GRIP plan by having the renter and/or landlord pay to protect and secure the landlord against lease default. Once any applicable upfront fees are paid and monthly payment schedules are set, the renter and the landlord may complete the lease and join the renter community. If a landlord is approved to receive GRIP, this may also be a statement of security for a prospective renter as not every landlord is eligible for GRIP. GRIP may provide a measure of exclusivity and network access that is attractive to renter consumers and landlords, and can be used to market to those groups. GRIP qualification may be synonymous with the SSL trust seal. If a landlord or renter has 5-star rating and GRIP, then consumer is the most sought after and trusted member, eligible to the best of benefits, deals, discounts, and awards. 5-star GRIP members may also be applied a label, for example, “Diamond Member,” and may be eligible to receive exclusive offers.

Information gathered from the start of the process until the lease is signed may be used to build the renter profile and established the renter score, which may be further developed while the renter is using the renter community. In the renter community, the renter may be communicating with other renters, landlords, maintenance people, vendors, paying rent online, and engaging in commerce. These activities may help build the renter score.

The renter can also start the landlord direct process by searching for apartments on the interface. Once a renter finds a rental listing, the renter may apply directly through the listing. The renter may communicate with the landlord via the communication component, schedule viewings, complete and send rental applications, rate viewing experience, landlord, property and unit, negotiating the lease, and joining the renter community, all of which may be done virtually and substantially automatically. A GRIP plan may be offered, as discussed above. The renter may also be provided access to the renter community, also as discussed above.

Referring now to flowchart 900 of FIG. 9, an illustrative method for a renter operation will be described, without limitation. Starting with block 902, the operation may begin by the renter accessing the system. (Block 910). The renter may be directed to their renter dashboard.

The renter may then choose a feature to interact with the system. (Block 920). If it is determined at block 920 that the renter desires to perform managing operations, the renter may be directed to manage information in their renter profile, and manage associated applications. (Block 922). The renter may additionally manage their appointments and viewings. (Block 924). Furthermore, the renter may manage authorization tokens, selecting whether to grant, restrict, or revoke associated rights. (Block 926). At the time the renter creates a profile, they may choose if they wish to be contacted by a landlord or agent and decide which profile may be visible to which type of user.

If it is determined at block 920 that the renter desires to perform search operations, the renter may be directed to optionally create a renter profile and/or login account. (Block 930). The renter may also manage co-applicants and related relationships, as discussed throughout this disclosure. The renter may be provided search features to locate available units. (Block 932).

It may then be determined whether the renter has a renter profile. (Block 940). If it is determined at block 940 that the renter is associated with a renter profile, the renter may be provided with an option to mark and view search history and/or favorites. (Block 942). The renter may also be provided an option to communicate with landlords and/or the community. (Block 944). The renter may be provided an option to apply for a transactional relationship for a real property unit, for example, by submitting a lease application. (Block 946). The operations of blocks 944 and 946 may include negotiation and signing of a lease. The renter may additionally be provided access to the tenant dashboard. (Block 948). Access to the tenant dashboard may be at least partially restricted if the renter has not yet transitioned into a tenant.

From block 926 or 950, or if block 940 was decided in the negative, the renter may then determine whether to terminate their session at block 950. If it is determined at block 950 not to terminate the session, the agent may then be redirected to again access the renter dashboard and system at block 910. If it is determined at block 950 to terminate the session, the operation may end at block 960.

While various aspects have been described in the above disclosure, the description of this disclosure is intended to illustrate and not limit the scope of the invention. The invention is defined by the scope of the appended claims and not the illustrations and examples provided in the above disclosure. Skilled artisans will appreciate additional aspects of the invention, which may be realized in alternative embodiments, after having the benefit of the above disclosure. Other aspects, advantages, embodiments, and modifications are within the scope of the following claims.

What is claimed is:

1. A network-leveraged system for facilitating a real property transaction comprising:
a database accessible via a network to store and communicate data relating to a transactional relationship and rules for determining a likelihood of compatibility between parties comprising a renter and a landlord;
platform components communicably connected to the database to analyze and manipulate the data, the platform components comprising:
a renter component to assemble a renter profile comprising renter information and analyze at least part of the renter profile to derive a renter score for association with the renter, the renter score being includable by the renter profile;
a matching component to compare at least part of the renter profile to the rules to determine whether the likelihood of compatibility with a landlord requirement relative to a real property unit meets a matching threshold, and matching the renter and the landlord for which the matching threshold is met;
a broker-assisted component to assist an agent with the transactional relationship comprising:
an agent renter CRM aspect to at least partially automate tasks related to the transactional relationship, and
a renter qualification aspect that works with the matching component to substantially identify the renter with the likelihood of compatibility with the landlord for the real property unit in consideration for the transactional relationship;
a token exchange aspect to coordinate sharing of at least part of the renter profile from the renter to the landlord, the renter granting access to an authorization token for the landlord of the real property unit for consideration for the transactional relationship, and wherein the authorization token is revocable; and
a lead marketplace component to selectively transact the renter profile; and
an interface accessible to interact with the data and at least one of the platform components.

2. The system of claim 1, further comprising:
a guaranteed rental income protection to assure financial stability in the transactional relationship;
wherein the rules comprise a threshold of eligibility for the guaranteed rental income protection;
wherein the guaranteed rental income protection is selectively offered for the transactional relationship that meets a threshold of eligibility; and
wherein the guaranteed rental income protection is marketable as a financial instrument.

3. The system of claim 1, wherein the renter component further comprises:
a renter profile validation aspect to receive documentation that is intended to validate at least part of the renter information included by the renter profile, the renter information determined not to be valid being selectively purged from the renter profile.

4. The system of claim 1, wherein the rules comprise:
the matching threshold for the likelihood of compatibility;
an assessment of renter qualification factors; and
an ability to afford rent for the real property unit.

5. The system of claim 1, wherein the renter score is determined from analyzing renter qualification factors comprising:
an income status;
a family size status;
a creditworthiness status; and
a regulatory restriction status.

6. The system of claim 1, wherein the broker-assisted component further comprises:
a commission protection aspect comprising an escrow to mitigate an attempt by the parties to bypass the agent.

7. The system of claim 1, wherein the broker-assisted component further comprises a team module comprising:
a virtual team aspect to facilitate sharing leads with the agent;
an agent management aspect for assigning the agent to a managing broker; and
a team monitoring aspect to analyze statistics relative to the agent and determine the data relative to performance of the agent, at least part of the data being associable with the agent.

8. The system of claim 1, wherein the platform components further comprise a landlord direct component comprising:
a renter search aspect to locate the renter prospective to engage in the transactional relationship relative to the real property unit, the renter being filterable by the renter score; and
wherein the landlord direct component communicates with the matching component to connect the renter having an acceptable likelihood of compatibility with the landlord.

9. The system of claim 8, wherein the landlord direct component further comprises:
a record keeping aspect to log at least part of communications between the parties; and
a renter community aspect to facilitate interaction between at least the renter, additional renters, and the landlord.

10. The system of claim 1, wherein the platform components further comprise a landlord management component comprising:
a landlord financial aspect to receive payments from the renter; and
a maintenance request aspect to receive a maintenance request for the real property unit.

11. The system of claim 10, wherein the landlord management component further comprises:
a landlord-vendor management aspect to request service from a vendor, manage costs to the vendor, and log interactions with the vendor.

12. The system of claim 1, wherein the platform components further comprise:
a communication component to facilitate interactions between the parties and organize the interactions, the interactions being recordable by the communication component; and
wherein the broker-assisted component operates with the communication component to facilitate communication between the parties and the agent.

13. The system of claim 1, further comprising a tenant exchange to transact rights to a tenant of the transactional relationship.

14. A network-leveraged system for facilitating a real property transaction comprising:
a database accessible via a network to store and communicate data relating to a transactional relationship and rules for determining a likelihood of compatibility between parties comprising a renter and a landlord;
platform components communicably connected to the database to analyze and manipulate the data, the platform components comprising:
a renter component to assemble a renter profile comprising renter information and analyze at least part of the renter profile to derive a renter score for association with the renter, the renter score being includable by the renter profile,
a matching component to compare at least part of the renter profile to the rules to determine whether the likelihood of compatibility with a landlord requirement relative to a real property unit meets a matching threshold, and matching the renter and the landlord for which the matching threshold is met,
a communication component to facilitate interactions between the parties and organize the interactions, the interactions being recordable by the communication component,
a landlord direct component comprising:
a renter search aspect to locate the renter prospective to engage in the transactional relationship relative to the real property unit, the renter being filterable by the renter score, and
wherein the landlord direct component communicates with the matching component to connect the renter having an acceptable likelihood of compatibility with the landlord,
a token exchange aspect to coordinate sharing of at least part of the renter profile from the renter to the landlord, the renter granting access to an authorization token for the landlord of the real property unit for consideration for the transactional relationship, and wherein the authorization token is revocable, and
a landlord management component comprising:
a landlord financial aspect to receive payments from the renter,
a maintenance request aspect to receive a maintenance request for the real property unit, and
a landlord-vendor management aspect to request service from a vendor, manage costs to the vendor, and/or log interactions with the vendor; and
an interface accessible to interact with the data and at least one of the platform components.

15. The system of claim 14, wherein the landlord direct component further comprises:
a record keeping aspect to log at least part of communications between the parties;
a renter community aspect to facilitate interaction between at least the renter, additional renters, and the landlord; and
wherein the renter score is determined from analyzing renter qualification factors comprising:
an income status,
a family size status,
a creditworthiness status, and
a regulatory restriction status.

16. The system of claim 14, further comprising:
a broker-assisted component to assist an agent with the transactional relationship comprising:
an agent renter CRM aspect to at least partially automate tasks related to the transactional relationship,
a renter qualification aspect that works with the matching component to substantially identify the renter with the likelihood of compatibility for the landlord with the real property unit in consideration for the transactional relationship,
a commission protection aspect comprising an escrow to mitigate an attempt by the parties to bypass the agent, and
a lead marketplace component to selectively transact the renter profile; and
wherein the broker-assisted component operates with the communication component to facilitate the communications between the parties and the agent.

17. The system of claim 14, further comprising:
a guaranteed rental income protection that is marketable as a financial instrument to assure financial stability in the transactional relationship;
wherein the rules comprise a threshold of eligibility for the guaranteed rental income protection; and
wherein the guaranteed rental income protection is selectively offered for the transactional relationship that meets a threshold of eligibility.

18. A method of facilitating a real property transaction via a network-leveraged system comprising:
(a) communicating data and rules stored in a database accessible via a network by platform components, the data relating to a transactional relationship, and the rules being at least for determining a likelihood of compatibility between parties comprising a renter and a landlord;
(b) managing a renter profile comprising renter information by a renter component and analyze at least part of the renter profile to derive a renter score for association with the renter, the renter score being includable by the renter profile;
(c) comparing at least part of the renter profile to the rules by a matching component to determine whether the likelihood of compatibility with a landlord requirement relative to a real property unit meets a matching threshold;
(d) matching the renter and the landlord for which the matching threshold is met; and
(e) selectively assuring financial stability in the transactional relationship via a guaranteed rental income protection;
wherein the rules comprise a threshold of eligibility for the guaranteed rental income protection;
wherein the guaranteed rental income protection is selectively offered for the transactional relationship that meets a threshold of eligibility;
wherein the system comprises a token exchange aspect to coordinate sharing of at least part of the renter profile from the renter to the landlord, the renter granting access to an authorization token for the landlord of the real property unit for consideration for the transactional relationship, and wherein the authorization token is revocable; and
wherein the system comprises an interface accessible to interact with the data and at least one of the platform components.

19. The method of claim 18, further comprising:
(f) assisting an agent with the transactional relationship by a broker-assisted component, further comprising:
(i) at least partially automating tasks related to the transactional relationship,
(ii) operating with the matching component to substantially identify the renter with the likelihood of compatibility for the landlord with the real property unit in consideration for the transactional relationship, and
(iii) coordinating sharing of at least part of the renter profile from the renter to the landlord via the token exchange aspect.

20. The method of claim 18, further comprising:
(g) assisting a landlord with the transactional relationship by a landlord direct component comprising:
(i) locating the renter prospective to engage in the transactional relationship relative to the real property unit, the renter being filterable by the renter score,
(ii) communicating with the matching component to connect the renter having an acceptable likelihood of compatibility with the landlord, and
(iii) coordinating sharing of at least part of the renter profile from the renter to the landlord via the token exchange aspect; and
wherein the system comprises a landlord management component comprising:
a landlord financial aspect to receive payments from the renter,
a maintenance request aspect to receive a maintenance request for the real property unit, and
a landlord-vendor management aspect to request service from a vendor, manage costs to the vendor, and log interactions with the vendor.
